(19) United States
(12) Patent Application Publication
(10) Pub. No.: US 2008/0167188 A1
(43) Pub. Date: Jul. 10, 2008

(54) Herbicide Combinations Comprising Special Ketoenoles

(76) Inventors: Reiner Fischer, Monheim (DE); Dieter Feucht, Eschborn (DE); Stefan Lehr, Liederbach (DE); Hans Philipp Huff, Eppstein (DE); Erwin Hacker, Hochheim (DE); Guido Bojack, Wiesbaden (DE)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/574,301

(22) PCT Filed: Aug. 20, 2005
(86) PCT No.: PCT/EP05/09017

§ 371 Date: Nov. 6, 2007

(30) Foreign Application Priority Data
Aug. 27, 2004 (DE) 10 2004 041 529.3

(51) Int. Cl. A01N 43/58; A01N 43/40; A01N 43/36; A01N 43/00

(52) U.S. Cl. 504/137; 504/130; 504/138; 504/139

(57) ABSTRACT

The invention provides herbicide combinations comprising an effective amount of components (A) and (B), where component (A) is one or more of the ketoenols listed in the description and (B) is one or more herbicides from the group of the known herbicides also listed in the description.

The invention also relates to the use of the combinations for controlling unwanted vegetation and to the corresponding method for controlling weeds.

The invention is in the technical field of crop protection compositions which can be used against harmful plants, for example in crop plants, and which comprise, as active compounds, a combination of at least two herbicides and, if appropriate, additionally crop plant compatibility-improving substances (safeners).

Ketoenols, their preparation and their use as herbicides and/or plant growth regulators are described in WO 04/080962 and WO 05/044796. The addition of safeners to ketoenols is also known in principle from WO 03/013249.

The effectiveness of these herbicides against harmful plants in the crop plants is at a high level; however, it depends in general on the application rate, the respective formulation, the harmful plants to be controlled in each case or the spectrum of harmful plants, the climatic and soil conditions, etc. A further criterion is the duration of action, or the rate of degradation of the herbicide. Also to be taken into account are, if appropriate, changes in the susceptibility of harmful plants which may occur on prolonged use of the herbicides or in specific geographical locations. Activity losses in individual harmful plants can only be compensated to a certain extent by higher application rates of the herbicides, for example because this frequently decreases the selectivity of the herbicides, or an improvement in activity is not observed, not even at higher application rates. In some cases, it is possible to improve the selectivity in crops by addition of safeners. In general, however, there is always a need for methods to achieve the herbicidal action with a lower application rate of active compounds. A lower application rate reduces not only the amount of an active compound which is required for the application, but generally also reduces the amount of formulation auxiliaries required. Both reduce the economic expense and improve the ecological compatibility of the herbicide treatment.

One possibility for improving the application profile of a herbicide may consist in the combination of the active compound with one or more other active compounds. However, when two or more active compounds are applied in combination, it is not uncommon for phenomena of physical and biological incompatibility to occur, for example lack of stability of a coformulation, decomposition of an active compound or antagonism of the active compounds. In contrast, what is desired are combinations of active compounds having a favorable activity profile, high stability and, if possible, synergistically enhanced activity, which permits a reduction of the application rate, compared with the individual application of the active compounds to be combined. Advantageous also is a broadening of the activity spectrum, an increased application flexibility and also faster onset of action and suitability for controlling herbicide-resistant species.

Surprisingly, it has now been found that certain active compounds from the group of the ketoenols interact in a particularly favorable manner in combination with certain structurally different herbicides, for example when they are used in crop plants suitable for the selective application of the herbicides, if appropriate with added safeners.

Accordingly, the invention provides herbicide combinations comprising an effective amount of components (A) and (B), where
(A) is one or more herbicides from the following group (A) of herbicides consisting of the compounds

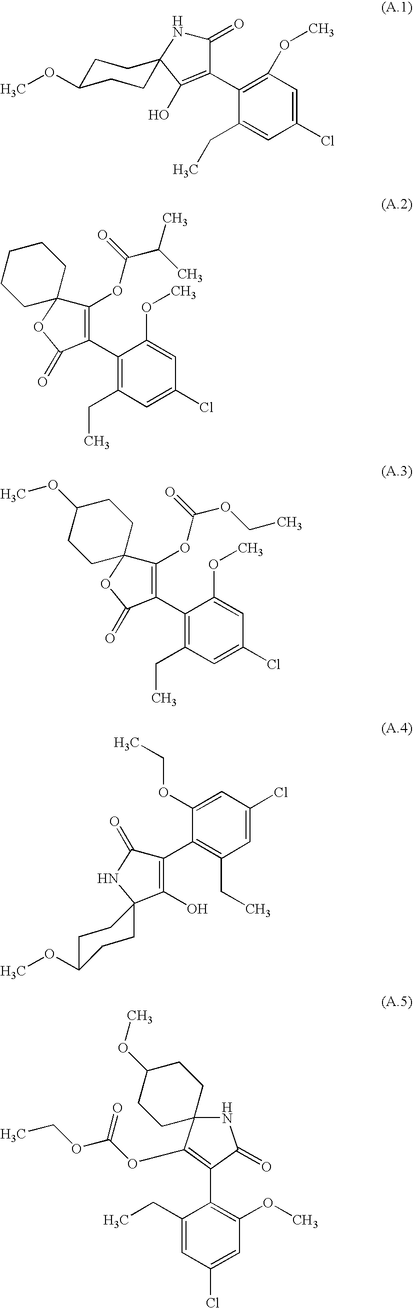

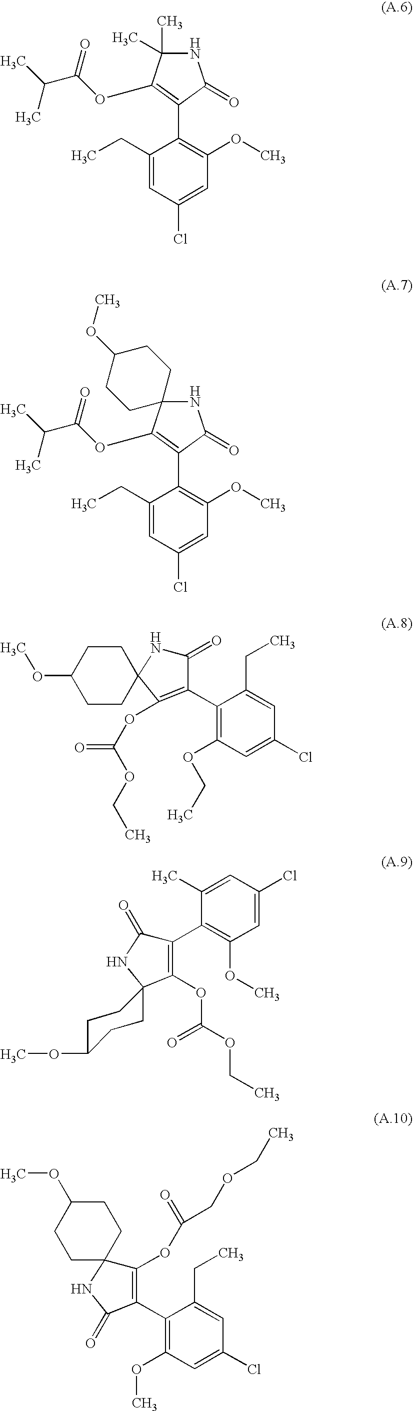

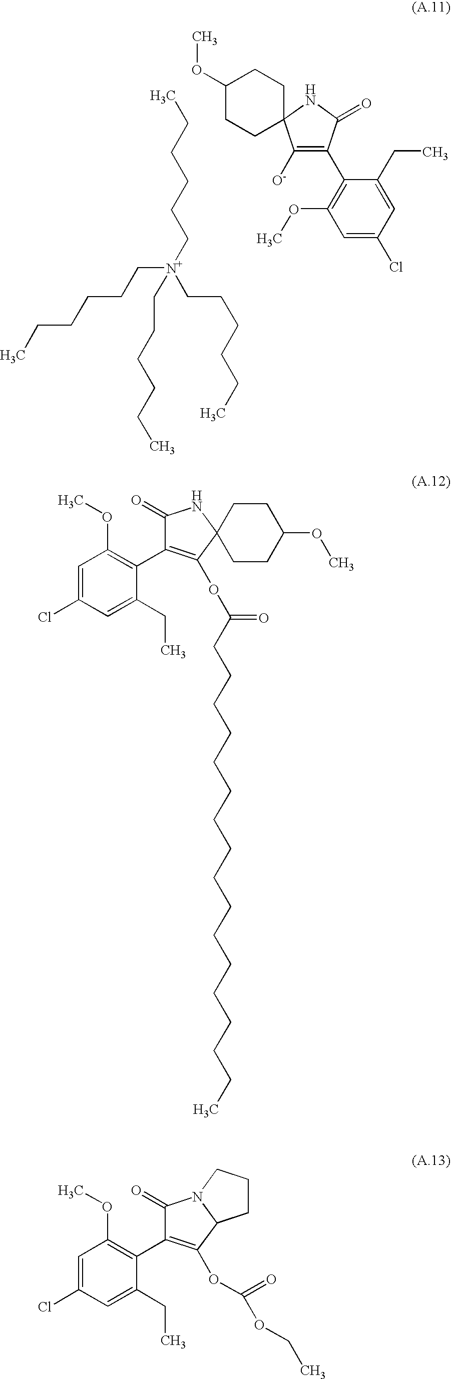

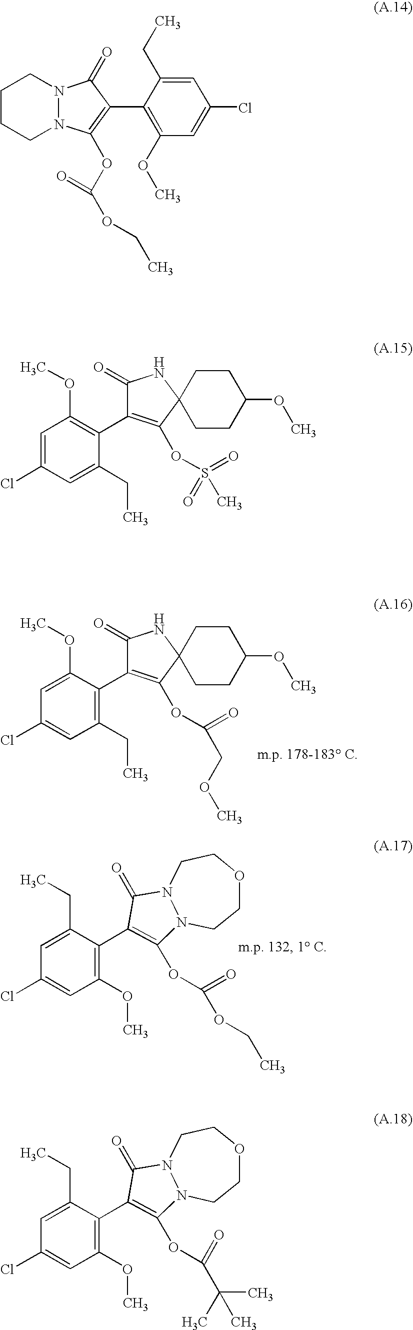

and
(B) is one or more herbicides from the groups (B1) to (B4),
group (B-1) comprising herbicides which are predominantly active against monocotyledonous harmful plants, from the group of the compounds consisting of (listed by the “common name” and a reference, for example from “The Pesticide Manual” 13th Ed., British Crop Protection Council 2003, abbreviated “PM”)
(B1.1) pinoxaden (WO 99/47525), for example 8-(2,6-diethyl-4-methylphenyl)-1,2,4,5-tetrahydro-7-oxo-7H-pyrazolo[1,2-d][1,4,5]oxadiazepin-9-yl-2,2-dimethylpropanoate
(B1.2) diclofop-methyl (PM, pp. 293-295), for example methyl 2-[4-(2,4-dichlorophenoxy)phenoxy]propanoate
(B1.3) clodinafop-propargyl (PM, pp. 186-187), for example (2-propynyl) (R)-2-[4-[(5-chloro-3-fluoro-2-pyridinyl)oxy]phenoxy]propanoate
(B1.4) cyhalofop-butyl (PM, pp. 229-232), for example butyl (R)-2-[4-(4-cyano-2-fluorophenoxy)phenoxy]propanoate
(B1.5) fenoxaprop-P-ethyl (PM, pp. 414-417), for example ethyl (R)-2-[4-[(6-chloro-2-benzoxazolyl)oxy]phenoxy]propanoate
(B1.6) haloxyfop-P (PM, pp. 52-527) and its esters, for example methyl (R)-2-[4-[[3-chloro-5-(trifluoromethyl)-2-pyridinyl]oxy]phenoxy]propanoate
(B1.7) fluazifop-P-butyl (PM, pp. 444-446), for example butyl (R)-2-[4-[[5-(trifluoromethyl)-2-pyridinyl]oxy]phenoxy]propanoate
(B1.8) quizalofop-P (PM, pp. 876-878) and its esters, for example ethyl 2-[4-(6-chloro-2-quinoxalinyloxy)phenoxy]propanoate
(B1.9) sethoxydim (PM, pp. 887-888), for example (+−)-2-[1-(ethoxyimino)butyl]-5-[2-(ethylthio)propyl]-3-hydroxy-2-cyclohexen-1-one
(B1.10)clethodim (PM, pp. 185-186), for example (E,E)-(+)-2-[1-[[(3-chloro-2-propenyl)oxy]imino]propyl]-5-[2-(ethylthio)propyl]-3-hydroxy-2-cyclohexen-1-one
(B1.11)tepraloxydim (PM, pp. 936-937), for example 2-[1-[[[(2E)-3-chloro-2-propenyl]-oxy]imino]propyl]-3-hydroxy-5-(tetrahydro-2H-pyran-4-yl)-2-cyclohexen-1-one
(B1.12)mesosulfuron-methyl (PM, pp. 630-632), for example methyl 2-[[[[(4,6-dimethoxy-2-pyrimidinyl)amino]carbonyl]amino]sulfonyl]-4-[[(methylsulfonyl)-amino]methyl]benzoate
(B1.13) iodosulfuron-methyl and its salts (PM, pp. 573-574), for example methyl 4-iodo-2-[[[[(4-methoxy-6-methyl-1,3,5-triazin-2-yl)amino]carbonyl]amino]sulfonyl]-benzoate, monosodium salt
(B1.14) sulfosulfuron (PM, pp. 913-915), for example N-[[(4,6-dimethoxy-2-pyrimidinyl)amino]carbonyl]-2-(ethylsulfonyl)imidazo[1,2-a]pyridine-3-sulfonamide
(B1.15)flupyrsulfuron-methyl and its salts (PM pp. 470-473), for example methyl 2-[[[[(4,6-dimethoxy-2-pyrimidinyl)amino]carbonyl]amino]sulfonyl]-6-(trifluoromethyl)-3-pyridinecarboxylate, monosodium salt
(B1.16)fentrazamide (PM, pp. 427-428), for example 4-(2-chlorophenyl)-N-cyclohexyl-N-ethyl-4,5-dihydro-5-oxo-1H-tetrazole-1-carboxamide
(B1.17) mefenacet (PM, pp. 621-622), for example 2-(2-benzothiazolyloxy)-N-methyl-N-phenylacetamide
(B1.18)imazamethabenz-methyl (PM, pp. 551-552), for example methyl 2-[4,5-dihydro-4-methyl-4-(1-methylethyl)-5-oxo-1H-imidazol-2-yl]-4 (or 5)-methylbenzoate
(B1.19)imazethapyr (PM, pp. 558-560), for example 2-[4,5-dihydro-4-methyl-4-(1-methylethyl)-5-oxo-1H-imidazol-2-yl]-5-ethyl-3-pyridinecarboxylic acid
(B1.20)imazamox (PM, pp. 552-553), for example 2-[4,5-dihydro-4-methyl-4-(1-methylethyl)-5-oxo-1H-imidazol-2-yl]-5-(methoxymethyl)-3-pyridinecarboxylic acid
(B1.21)flurtamone (PM, pp. 482-483), for example 5-(methylamino)-2-phenyl-4-[3-(trifluoromethyl)phenyl]-3(2H)-furanone
(B1.22)isoproturon (PM, pp. 584-585), for example N,N-dimethyl-N′-[4-(1-methylethyl)-phenyl]urea
(B1.23)quinclorac (PM pp. 869-870), for example 3,7-dichloro-8-quinolinecarboxylic acid and
group (B-2) comprising herbicides which are predominantly active against grass-like and dicotyledonous harmful plants, from the group of the compounds consisting of (listed by the “common name” and a reference, for example from “The Pesticide Manual” 13th Ed., British Crop Protection Council 2003, abbreviated “PM”)
(B2.1) 2,4-DB (PM, pp. 264-266) and its salts and esters, for example (2,4-dichlorophenoxy)acetic acid
(B2.2) dicamba (PM, pp. 278-280) and its salts and esters, for example 3,6-dichloro-2-methoxybenzoic acid
(B2.3) clomazone (PM, p. 191), for example 2-[(2-chlorophenyl)methyl]-4,4-dimethyl-3-isoxazolidinone
(B2.4) triclopyr (PM, pp. 1001-1002) and its salts and esters, for example [(3,5,6-trichloro-2-pyridinyl)oxy]acetic acid
(B2.5) fluoroxypyr and its salts and esters (PM, pp. 478-481), for example 1-methylheptyl [(4-amino-3,5-dichloro-6-fluoro-2-pyridinyl)oxy]acetate
(B2.6) thifensulfuron-methyl (PM, pp. 963-965), for example methyl 3-[[[[(4-methoxy-6-methyl-1,3,5-triazin-2-yl)amino]carbonyl]amino]sulfonyl]-2-thiophenecarboxylate
(B2.7) amidosulfuron (PM, pp. 27-28), for example N-[[[[(4,6-dimethoxy-2-pyrimidinyl)amino]carbonyl]amino]sulfonyl]-N-methyl-methanesulfonamide
(B2.8) tribenuron-methyl (PM, pp. 996-998), for example methyl 2-[[[[(4-methoxy-6-methyl-1,3,5-triazin-2-yl)methylamino]carbonyl]amino]sulfonyl]benzoate
(B2.9) metsulfuron-methyl (PM pp. 677-678), for example methyl 2-[[[[(4-methoxy-6-methyl-1,3,5-triazin-2-yl)amino]carbonyl]amino]sulfonyl]benzoate
(B2.10)picloram and its salts and esters (PM pp. 782-785), for example 4-amino-3,5,6-trichloro-2-pyridinecarboxylic acid
(B2.11)carfentrazone-ethyl (PM pp. 143-144), for example ethyl α,2-dichloro-5-[4-(difluoromethyl)-4,5-dihydro-3-methyl-5-oxo-1H-1,2,4-triazol-1-yl]-4-fluorobenzenepropanoate
(B2.12)chlopyralid (PM, pp. 194-195), for example 3,6-dichloro-2-pyridinecarboxylic acid
(B2.13) batafenacil (PM, pp. 120-121), for example 1,1-dimethyl-2-oxo-2-(2-propenyloxy)ethyl 2-chloro-5-[3,6-dihydro-3-methyl-2,6-dioxo-4-(trifluoromethyl)-1(2H)-pyrimidinyl]benzoate
(B2.14)isoxaben (PM, pp. 587-588), for example N-[3-(1-ethyl-1-methylpropyl)-5-isoxazolyl]-2,6-dimethoxybenzamide
(B2.15)thiazopyr (PM, pp. 961-962), for example methyl 2-(difluoromethyl)-5-(4,5-dihydro-2-thiazolyl)-4-(2-methylpropyl)-6-(trifluoromethyl)-3-pyridinecarboxylate
(B2.16)flurtamone (PM, pp. 482-483), for example 5-(methylamino)-2-phenyl-4-[3-(trifluoromethyl)phenyl]-3(2H)-furanone
(B2.17) aclonifen (PM, p. 13), for example 2-chloro-6-nitro-3-phenoxybenzenamine
(B2.18)lactofen (PM, pp. 596-597), for example (2-ethoxy-1-methyl-2-oxoethyl)-5-[2-chloro-4-(trifluoromethyl)phenoxy]-2-nitrobenzoate
(B2.19) fomesafen (PM, pp. 492-493), for example 5-[2-chloro-4-(trifluoromethyl)-phenoxy]-N-(methylsulfonyl)-2-nitrobenzamide
(B2.20)chlorimuron-ethyl (PM, pp. 161-162), ethyl 2-[[[[(4-chloro-6-methoxy-2-pyrimidinyl)amino]carbonyl]amino]sulfonyl]benzoate
(B2.21) mesotrione (PM, pp. 631-632), 2-[4-(methylsulfonyl)-2-nitrobenzoyl]-1,3-cyclohexanedione
(B2.22)sulcotrione (PM, pp. 908-909), for example 2-[2-chloro-4-(methylsulfonyl)-benzoyl]-1,3-cyclohexanedione

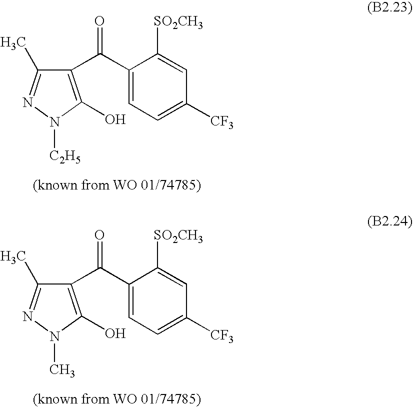

(B2.25) bromoxynil (PM, pp. 111-113) and its salts and esters, for example 3,5-dibromo-4-hydroxybenzonitrile
(B2.26) ioxynil (PM, pp. 574-576) and its salts and esters, for example 4-hydroxy-3,5-diiodobenzonitrile
(B2.27) diflufenican (PM, pp. 310-311), for example N-(2,4-difluorophenyl)-2-[3-(trifluoromethyl)phenoxy]-3-pyridinecarboxamide
(B2.28) picolinafen (PM, pp. 785-786), for example N-(4-fluorophenyl)-6-[3-(trifluoromethyl)phenoxy]-2-pyridinecarboxamide and
group (B-3) comprising herbicides which are predominantly active against dicotyledonous harmful plants, from the group of compounds consisting of (listed by the “common name” and a reference, for example from “The Pesticide Manual” 13th Ed., British Crop Protection Council 2003, abbreviated “PM”)
(B3.1) foramsulfuron (PM, pp. 494-495), for example 2-[[[[(4,6-dimethoxy-2-pyrimidinyl)amino]carbonyl]amino]sulfonyl]-4-(formylamino)-N,N-dimethylbenzamide
(B3.2) iodosulfuron-methyl and its salts (PM, pp. 573-574), for example methyl 4-iodo-2-[[[[(4-methoxy-6-methyl-1,3,5-triazin-2-yl)amino]carbonyl]-amino]sulfonyl]benzoate, monosodium salt
(B3.3) sulfosulfuron (PM, pp. 913-915), for example N-[[(4,6-dimethoxy-2-pyrimidinyl)amino]carbonyl]-2-(ethylsulfonyl)imidazo[1,2-a]pyridine-3-sulfonamide
(B3.4) amicarbazone (PM, pp. 26-27), for example 4-amino-N-(1,1-dimethylethyl)-4,5-dihydro-3-(1-methylethyl)-5-oxo-1H-1,2,4-triazole-1-carboxamide
(B3.5) propoxycarbazone-sodium (PM, pp. 831-832), for example methyl 2-[[[(4,5-dihydro-4-methyl-5-oxo-3-propoxy-1H-1,2,4-triazol-1-yl)carbonyl]amino]sulfonyl]benzoate, sodium salt
(B3.6) flucarbazone-sodium (PM, pp. 447-448), for example 4,5-dihydro-3-methoxy-4-methyl-5-oxo-N-[[2-(trifluoromethoxy)phenyl]sulfonyl]-1H-1,2,4-triazole-1-carboxamide, sodium salt
(B3.7) flufenacet (PM, pp. 454-455), for example N-(4-fluorophenyl)-N-(1-methylethyl)-2-[[5-(trifluoromethyl)-1,3,4-thiadiazol-2-yl]oxy]acetamide
(B3.8) metribuzin (PM, pp. 675-676), for example 4-amino-6-(1,1-dimethylethyl)-3-(methylthio)-1,2,4-triazin-5(4H)-one
(B3.9) triasulfuron (PM, pp. 990-991), for example 2-(2-chloroethoxy)-N-[[(4-methoxy-6-methyl-1,3,5-triazin-2-yl)amino]carbonyl]benzenesulfonamide
(B3.10) naproanilide (PM, pp. 695-696), for example 2-(2-naphthalenyloxy)-N-phenylpropanamide
(B3.11) imazapyr (PM, pp. 555-556), for example 2-[4,5-dihydro-4-methyl-4-(1-methylethyl)-5-oxo-1H-imidazol-2-yl]-3-pyridinecarboxylic acid
(B3.12) sulfosate (EP-A 54382), for example trimethylsulfonium N-phosphonomethylglycine
(B3.13) simazine (PM, pp. 891-892), for example 6-chloro-N,N′-diethyl-1,3,5-triazine-2,4-diamine
(B3.14) trifluralin (PM, pp. 1012-1014), for example 2,6-dinitro-N,N-dipropyl-4-(trifluoromethyl)benzenamine
(B3.15) pendimethalin (PM, pp. 752-753), for example N-(1-ethylpropyl)-3,4-dimethyl-2,6-dinitrobenzenamine
(B3.16) oxadiargyl (PM, pp. 725-726), for example 3-[2,4-dichloro-5-(2-propynyloxy)phenyl]-5-(1,1-dimethylethyl)-1,3,4-oxadiazol-2(3H)-one
(B.3.17) oryzalin (PM, pp. 723-724), for example 4-(dipropylamino)-3,5-dinitrobenzenesulfonamide
(B3.18) flazasulfuron (PM, pp. 437-438), for example N-[[(4,6-dimethoxy-2-pyrimidinyl)amino]carbonyl]-3-(trifluoromethyl)-2-pyridinesulfonamide
(B3.19) sulfometuron-methyl (PM, pp. 912-913), for example methyl 2-[[[[(4,6-dimethyl-2-pyrimidinyl)amino]carbonyl]amino]sulfonyl]benzoate
(B3.20) metazachlor (PM, pp. 641-642), for example 2-chloro-N-(2,6-dimethylphenyl)-N-(1H-pyrazol-1-ylmethyl)acetamide
(B3.21) metolachlor (PM, pp. 668-669), 2-chloro-N-(2-ethyl-6-methylphenyl)-N-(2-methoxy-1-methylethyl)acetamide
(B3.22) S-metolachlor (PM, pp. 669-670), for example (S)-2-chloro-N-(2-ethyl-6-methylphenyl)-N-(2-methoxy-1-methylethyl)acetamide
(B3.23) alachlor (PM, pp. 17-19), for example 2-chloro-N-(2,6-diethylphenyl)-N-(methoxymethyl)acetamide
(B3.24) atrazine (PM, pp. 39-41), for example 6-chloro-N-ethyl-N′-(1-methylethyl)-1,3,5-triazine-2,4-diamine
(B3.25) isoxaflutole (PM, pp. 589-590), for example (5-cyclopropyl-4-isoxazolyl)[2-(methylsulfonyl)-4-(trifluoromethyl)phenyl]methanone
(B3.26) quinmerac (PM, pp. 870-871), for example 7-chloro-3-methyl-8-quinolinecarboxylic acid
(B3.27) flumiclorac-pentyl (PM, pp. 460-461), for example pentyl [2-chloro-4-fluoro-5-(1,3,4,5,6,7-hexahydro-1,3-dioxo-2H-isoindol-2-yl)phenoxy]-acetate
(B3.28) quinclorac (PM pp. 869-870), for example 3,7-dichloro-8-quinolinecarboxylic acid

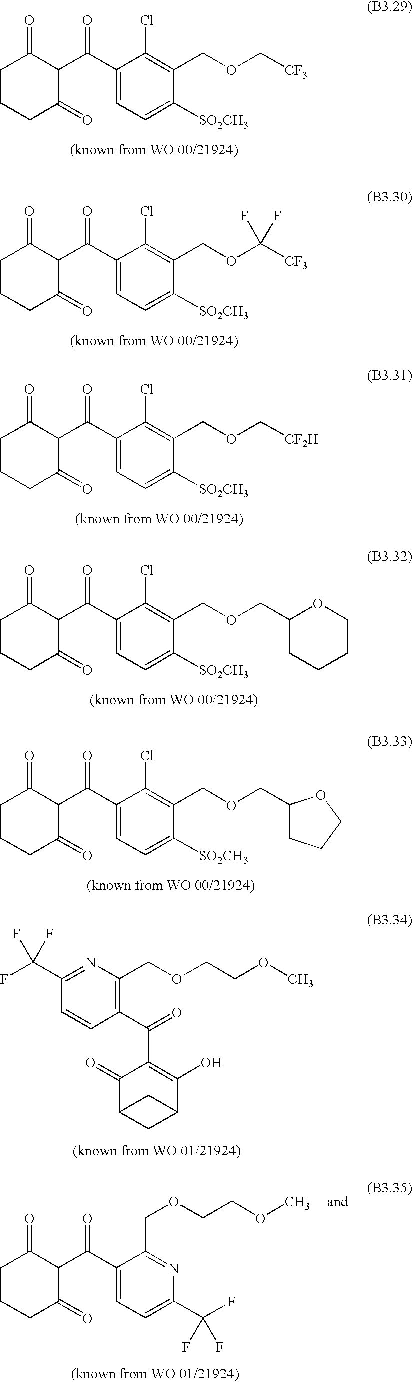

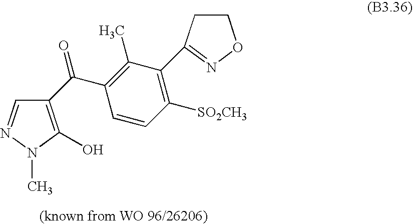

group (B-4) comprising predominantly non-selective herbicides from the group of compounds consisting of (listed by the “common name” and a reference, for example from “The Pesticide Manual” 13th Ed., British Crop Protection Council 2003, abbreviated “PM”)
(B4.1) glyphosate, for example N-(phosphonomethyl)glycine, which is preferably used as glyphosate-isopropylammonium, glyphosate-sesquisodium, glyphosate-trimesium (PM, pp. 513-516)
(B4.2) glufosinate, also including glufosinate-P, for example 4-[hydroxy(methyl)phosphinoyl]-DL-homoalanine, 4-[hydroxy(methyl)-phosphinoyl]-L-homoalanine, which are in each case preferably used as glufosinate-ammonium or glufosinate-P-ammonium (PM, pp. 511-512)
(B4.3) oxyflourfen (PM, pp. 738-739), for example 2-chloro-1-(3-ethoxy-4-nitrophenoxy)-4-(trifluoromethyl)benzene
(B4.4) diuron (PM, pp. 347-348), for example N′-(3,4-dichlorophenyl)-N,N-dimethylurea
(B4.5) MSMA, for example monosodium methylarsonate
(B4.6) bromacil (PM, pp. 106-107), for example 5-bromo-6-methyl-3-(1-methylpropyl)-2,4(1H,3H)-pyrimidinedione
(B4.7) norflurazon (PM, pp. 711-712), 4-chloro-5-(methylamino)-2[3-(trifluoromethyl)phenyl]-3(2H)-pyridazinone
(B4.8) azafenidin (DE-A 28 01 429), for example 2-[2,4-dichloro-5-(2-propynyloxy)phenyl]-5,6,7,8-tetrahydro-1,2,4-triazolo[4,3-a]pyridin-3(2H)-one
(B4.9) tebuthiuron (PM, pp. 929-930), for example N-[5-(1,1-dimethylethyl)-1,3,4-thiadiazol-2-yl]-N,N′-dimethylurea.

If, in the context of this description, the short form of the “common name” of an active compound is used, this comprises in each case all customary derivatives, such as the esters and salts, and isomers, in particular optical isomers, especially the commercially available form or forms. If the “common name” refers to an ester or a salt, this in each case also comprises all other customary derivatives, such as other esters and salts, the free acids and neutral compounds, and isomers, in particular optical isomers, especially the commercially available form or forms. The given chemical compound names refer to at least one of the compounds embraced by the “common name”, frequently to a preferred compound. In the case of sulfonamides such as sulfonylureas, salts also include salts formed by exchanging a hydrogen atom of the sulfonamide group for a cation.

When using the herbicide combinations according to the invention, the herbicides of group (B1) are particularly suitable for controlling monocotyledonous harmful plants, the herbicides of group (B2) are particularly suitable for controlling weed grasses and dicotyledonous harmful plants, the herbicides of group (B3) are particularly suitable for controlling dicotyledonous harmful plants and the herbicides of group (B4) are particularly suitable for the non-selective control of harmful plants or of harmful plants in transgenic crops.

The herbicide combinations according to the invention comprise a herbicidally effective amount of components (A) and (B) and may comprise further components, for example agrochemically active compounds of a different type and/or additives customary in crop protection and/or formulation auxiliaries, or may be used together with these compounds. Preference is given to herbicide combinations comprising a synergistically effective amount of components (A) and (B).

In a preferred embodiment, the herbicide combinations according to the invention have synergistic actions. The synergistic actions can be observed, for example, when the active compounds (A) and (B) are applied together; however, they can frequently also be observed when the active compounds are applied at different times (splitting). It is also possible to apply the individual herbicides or the herbicide combinations in a plurality of portions (sequential application), for example pre-emergence applications followed by post-emergence applications or early post-emergence applications followed by medium or late post-emergence applications. Preference is given here to the joint or almost simultaneous application of the active compounds of the herbicide combinations according to the invention.

The synergistic effects permit a reduction of the application rates of the individual active compounds, a higher efficacy at the same application rate, the control of species which are as yet uncontrolled (gaps), an extension of the period of application and/or a reduction in the number of individual applications and—as a result for the user—weed control systems which are more advantageous economically and ecologically.

For example, the combinations according to the invention of herbicides (A)+(B) allow the activity to be synergistically enhanced in a manner which by far and unexpectedly exceeds the activities which can be achieved with the individual herbicides (A) and (B).

The formulae mentioned in groups (A) and (B) include all stereoisomers and their mixtures, in particular also racemic mixtures, and—if enantiomers are possible—the respective biologically active enantiomers.

Compounds of group (A) are described, for example, in DE-A-10 311 300 or DE-A-10 351 646. The compounds A.16, A.17 and A.18 are not yet known. They can be prepared according to the method specified in DE-A-10 311 300. Owing to their particular herbicidal activity and their suitability for use as herbicides in crop protection, these compounds and herbicidal compositions comprising the compounds A.16, A.17 and A.18 also form part of the subject matter of the present application.

The compounds of groups (B1) to (B4) are known herbicides. The following group members are particularly preferred as mixing partners of the compounds of component (A):

From group (B1): diclofop-methyl (B1.2); fenoxaprop-P-ethyl (B1.5), mesosulfuron-methyl (B1.12), iodosulfuron-methyl-sodium (B1.13), fentrazamide (B1.16), mefenacet (B1.17), flurtamone (B1.21), isoproturon (B1.22).

From group (B2): amidosulfuron (B2.7), flurtamone (B2.16), aclonifen (B2.17), lactofen (B2.18), bromoxynil (B2.25), ioxynil (B2.26), diflufenican (B2.27).

From group (B3): foramsulfuron (B3.1), iodosulfuron-methyl-sodium (B3.2), amicarbazone (B3.4), propoxycarbazone-sodium (B3.5), flucarbazone-sodium (B3.6), flufenacet (B3.7), metazachlor (B3.20), isoxaflutole (B3.25), compound (B3.29), compound (B3.30), compound (B3.31), compound (B3.32), compound (B3.33).

From group (B4): glufosinate (B4.2), diuron (B4.4).

Preference is given to herbicide combinations of one or more herbicides (A) with one or more herbicides (B), preferably from group (B1) or (B2), (B3) or (B4). Preference is furthermore given to combinations of herbicide (A) with one or more herbicides (B) according to the scheme: (A)+(B1)+(B2), (A)+(B1)+(B3), (A)+(B1)+(B4), (A)+(B2)+(B3), (A)+(B2)+(B4), (A)+(B3)+(B4) or (A)+(B1)+(B2)+(B3).

The application rate of the active compounds of groups (A) and (B) may vary within wide ranges, for example between 0.001 and 8 kg of AS/ha. Whenever the abbreviation AS/ha is used in the present description, this is to be understood as meaning “active substance per hectare”, based on 100% pure active compounds.

In the combinations according to the invention between compounds of groups (A) and (B1), the compounds of group (B1) are usually applied at an application rate of from 0.001 to 1.5 kg of AS/ha, preferably from 0.005 to 1.2 kg of AS/ha. In the other combinations between compounds of groups (A) and (B), the compounds of group (B) are usually applied at an application rate of from 0.001 to 8 kg of AS/ha, preferably from 0.005 to 5 kg of AS/ha. In the combinations according to the invention, the compound of group (A) or the compounds of group (A) are preferably employed at an application rate of from 1 to 120 g of AS/ha.

The mixing ratio of the compounds of group (A) to those of group (B1) is advantageously from 1:1500 to 120:1, preferably from 1:400 to 18:1. The mixing ratio of the compounds of group (A) to those of group (B2), (B3) or (B4) is advantageously from 1:8000 to 800:1, preferably from 1:100 to 100:1.

The active compounds can generally be formulated as a water-soluble wettable powder (WP), as water-dispersible granules (WDG), as water-emulsifiable granules (WEG), as a suspoemulsion (SE) or as an oil suspension concentrate.

When using the active compounds of groups (A) and (B) in crop plants, it may be expedient, depending on the crop plant, to apply a safener above certain application rates to reduce or avoid possible damage to the crop plant. Examples of suitable safeners are those which act as safeners in combination with ketoenol herbicides. Suitable safeners are known from WO 03/013249.

The following groups of compounds are, for example, suitable as safeners for the herbicidally active compounds (A) and (B) mentioned above:
a) Compounds of the type of the dichlorophenylpyrazoline-3-carboxylic acid (S1), preferably compounds such as ethyl 1-(2,4-dichlorophenyl)-5-(ethoxycarbonyl)-5-methyl-2-pyrazoline-3-carboxylate (S1-1, mefenpyr-diethyl, PM, pp. 594-595), and related compounds, as described, for example, in WO 91/07874 and PM (pp. 594-595).
b) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
c) Compounds of the type of the triazolecarboxylic acids (S1), preferably compounds such as fenchlorazole, i.e. ethyl 1-(2,4-dichlorophenyl)-5-trichloromethyl-(1H)-1,2,4-triazole-3-carboxylate (S1-6), and related compounds (see EP-A-174 562 and EP-A-346 620).
d) Compounds of the type of the 5-benzyl- or 5-phenyl-2-isoxazoline-3-carboxylic acid or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described, for example, in WO 91/08202, or of 5,5-diphenyl-2-isoxazoline-3-carboxylic acid and its ethyl ester (S1-9, isoxadifen-ethyl) or its n-propyl ester (S1-10) or of ethyl 5-(4-fluorophenyl)-5-phenyl-2-isoxazoline-3-carboxylate (S1-11), as described in the patent application (WO-A-95/07897).
e) Compounds of the type of the 8-quinolinoxyacetic acid (S2), preferably 1-methylhex-1-yl (5-chloro-8-quinolinoxy)acetate (S2-1, cloquintocet-mexyl, for example PM, pp. 195-196), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)-acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366.
f) Compounds of the type of the (5-chloro-8-quinolinoxy)malonic acid, preferably compounds such as diethyl (5-chloro-8-quinolinoxy)malonate, dialllyl (5-chloro-8-quinolinoxy)malonate, methyl ethyl (5-chloro-8-quinolinoxy)malonate and related compounds, as described in EP-A-0 582 198.
g) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxypropionic esters (mecoprop), MCPA or 3,6-dichloro-2-methoxybenzoic acid (esters) (dicamba).
h) Active compounds of the type of the pyrimidines, such as “fenclorim” (PM, pp. 386-387) (=4,6-dichloro-2-phenylpyrimidine),
i) active compounds of the type of the dichloracetamides, which are frequently used as pre-emergence safeners (soil-active safeners), such as, for example,
   “dichlormid” (PM, pp. 270-271) (=N,N-diallyl-2,2-dichloroacetamide),
   AR-29148″ (=3-dichloroacetyl-2,2,5-trimethyl-1,3-oxazolidone from Stauffer),
   “benoxacor” (PM, pp. 74-75) (=4-dichloroacetyl-3,4-dihydro-3-methyl-2H-1,4-benzoxazine),
   APPG-1292″ (=N-allyl-N-[(1,3-dioxolan-2-yl)methyl]dichloroacetamide from PPG Industries),
   ADK-24″ (=N-allyl-N-[(allylaminocarbonyl)methyl]dichloroacetamide from Sagro-Chem),
   AAD-67″ or AMON 4660″ (=3-dichloroacetyl-1-oxa-3-azaspiro[4,5]decane from Nitrokemia or Monsanto),
   “diclonon” or ABAS145138″ or ALAB145138″ (=3-dichloroacetyl-2,5,5-trimethyl-1,3-diazabicyclo[4.3.0]nonane from BASF) and
   “furilazole” or AMON 13900″ (see PM, pp. 482-483) (=(RS)-3-dichloroacetyl-5-(2-furyl)-2,2-dimethyloxazolidone),
j) active compounds of the type of the dichloroacetone derivatives, such as, for example, AMG 191″ (CAS-Reg. No. 96420-72-3) (=2-dichloromethyl-2-methyl-1,3-dioxolane from Nitrokemia),
k) active compounds of the type of the oxyimino compounds, which are known as seed dressings, such as, for example,
   “oxabetrinil” (PM, p. 689) (=(Z)-1,3-dioxolan-2-ylmethoxyimino(phenyl)acetonitrile), which is known as a seed dressing safener against damage caused by metolachlor,
   “fluxofenim” (PM, pp. 467-468) (=1-(4-chlorophenyl)-2,2,2-trifluoro-1-ethanone O-(1,3-dioxolan-2-ylmethyl oxime), which is known as a seed dressing safener against damage caused by metolachlor, and
   “cyometrinil” or A-CGA-43089″ (PM, p. 983) (=(Z)-cyanomethoxyimino-(phenyl)acetonitrile), which is known as a seed dressing safener against damage caused by metolachlor,
l) active compounds of the type of the thiazolecarboxylic acid esters, which are known as seed dressings, such as, for example,
   “flurazole” (PM, pp. 450-451) (=benzyl 2-chloro-4-trifluoromethyl-1,3-thiazole-5-carboxylate), which is known as a seed dressing safener against damage caused by alachlor and metolachlor,
m) active compounds of the type of the naphthalenedicarboxylic acid derivatives, which are known as seeding dressings, such as, for example,
   “naphthalic anhydride” (PM, pp. 1009-1010) (=1,8-naphthalenedicarboxylic anhydride), which is known as a seed dressing safener for corn against damage caused by thiocarbamate herbicides,
n) active compounds of the type of the chromanacetic acid derivatives, such as, for example, ACL 304415″ (CAS-Reg. No. 31541-57-8) (=2-84-carboxychroman-4-yl)acetic acid from American Cyanamid),
o) active compounds which, in addition to a herbicidal action against harmful plants, also have safener action in crop plants, such as, for example,
   “dimepiperate” or AMY-93″ (PM, pp. 302-303) (═S-1-methyl-1-phenylethyl piperidine-1-thiocarboxylate),
   “daimuron” or ASK 23″ (PM, p. 247) (=1-(1-methyl-1-phenylethyl)-3-p-tolyl-urea),
   “cumyluron”=AJC-940″ (=3-(2-chlorophenylmethyl)-1-(1-methyl-1-phenylethyl)urea, see JP-A-60087254),
   “methoxyphenone” or ANK 049″ (=3,3′-dimethyl-4-methoxybenzophenone),
   “CSB” (=1-bromo-4-(chloromethylsulfonyl)benzene) (CAS-Reg. No. 54091-06-4 from Kumiai),
   compounds of the type of the acylsulfamoylbenzamides, for example of formula (VIII) below, which are known, for example, from WO 99/16744.

| | |
|---|---|
| | (VIII) |
| 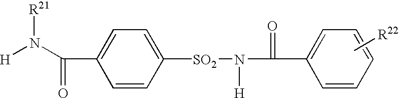 | |

| Compound No. | R²¹ | R²² |
|---|---|---|
| S3-1 | cyclopropyl | 2-OCH₃ |
| S3-2 | cyclopropyl | 2-OCH₃, 5-Cl |
| S3-3 | ethyl | 2-OCH₃ |
| S3-4 | isopropyl | 2-OCH₃, 5-Cl |
| S3-5 | isopropyl | 2-OCH₃ |

The herbicide combinations according to the invention are, if appropriate in the presence of safeners, suitable for controlling harmful plants in crop plants, for example in economically important crops, such as cereals (for example wheat, barley, rye, oats, rice, corn, millet), sugar beet, sugar cane, oilseed rape, cotton and soybeans. Of particular interest here is the use in cereals, in particular wheat, barley, rye, oats, crossbreeds thereof, such as triticale, rice, corn and millet, and also in dicotyledonous crops, in each case by the pre- and post-emergence method.

The invention also embraces herbicide combinations which, in addition to components (A) and (B), also comprise one or more further agrochemically active compounds of a different structure, such as herbicides, insecticides, fungicides or safeners. The preferred conditions outlined in particular for combinations (A)+(B) according to the invention also apply primarily to these combinations if they comprise the combinations (A)+(B) according to the invention, with respect to the combination (A)+(B) in question.

Of particular interest is the application of herbicidal compositions comprising the following compounds (A)+(B):

(A.1)+(B1.1); (A.1)+(B1.2); (A.1)+(B1.3); (A.1)+(B1.4); (A.1)+(B1.5); (A.1)+(B1.6); (A.1)+(B1.7); (A.1)+(B1.8); (A.1)+(B1.9); (A.1)+(B1.10); (A.1)+(B1.11); (A.1)+(B1.12); (A.1)+(B1.13); (A.1)+(B1.14); (A.1)+(B1.15); (A.1)+(B1.16); (A.1)+(B1.17); (A.1)+(B1.18); (A.1)+(B1.19); (A.1)+(B1.20); (A.1)+(B1.21); (A.1)+(B1.22); (A.1)+(B1.23); (A.1)+(B2.l); (A.1)+(B2.2); (A.1)+(B2.3); (A.1)+(B2.4); (A.1)+(B2.5); (A.1)+(B2.6); (A.1)+(B2.7); (A.1)+(B2.8); (A.1)+(B2.9); (A.1)+(B2.10); (A.1)+(B2.11); (A.1)+(B2.12); (A.1)+(B2.13); (A.1)+(B2.14); (A.1)+(B2.15); (A.1)+(B2.16); (A.1)+(B2.17); (A.1)+(B2.18); (A.1)+(B2.19); (A.1)+(B2.20); (A.1)+(B2.21); (A.1)+(B2.22); (A.1)+(B2.23); (A.1)+(B2.24); (A.1)+(B2.25); (A.1)+(B2.26); (A.1)+(B2.27); (A.1)+(B2.28); (A.1)+(B3.1); (A.1)+(B3.2); (A.1)+(B3.3); (A.1)+(B3.4); (A.1)+(B3.5); (A.1)+(B3.6); (A.1)+(B3.7); (A.1)+(B3.8); (A.1)+(B3.9); (A.1)+(B3.10); (A.1)+(B3.11); (A.1)+(B3.12); (A.1)+(B3.13); (A.1)+(B3.14); (A.1)+(B3.15); (A.1)+(B3.16); (A.1)+(B3.17); (A.1)+(B3.18); (A.1)+(B3.19); (A.1)+(B3.20); (A.1)+(B3.21); (A.1)+(B3.22); (A.1)+(B3.23); (A.1)+(B3.24); (A.1)+(B3.25); (A.1)+(B3.26); (A.1)+(B3.27); (A.1)+(B3.28); (A.1)+(B3.29); (A.1)+(B3.30); (A.1)+(B3.31); (A.1)+(B3.32); (A.1)+(B3.33); (A.1)+(B3.34); (A.1)+(B3.35); (A.1)+(B3.36); (A.1)+(B4.1); (A.1)+(B4.2); (A.1)+(B4.3); (A.1)+(B4.4); (A.1)+(B4.5); (A.1)+(B4.6); (A.1)+(B4.7); (A.1)+(B4.8); (A.1)+(B4.9).

(A.2)+(B1.1); (A.2)+(B1.2); (A.2)+(B1.3); (A.2)+(B1.4); (A.2)+(B1.5); (A.2)+(B1.6); (A.2)+(B1.7); (A.2)+(B1.8); (A.2)+(B1.9); (A.2)+(B1.10); (A.2)+(B1.11); (A.2)+(B1.12); (A.2)+(B1.13); (A.2)+(B1.14); (A.2)+(B1.15); (A.2)+(B1.16); (A.2)+(B1.17); (A.2)+(B1.18); (A.2)+(B1.19); (A.2)+(B1.20); (A.2)+(B1.21); (A.2)+(B1.22); (A.2)+(B1.23); (A.2)+(B2.1); (A.2)+(B2.2); (A.2)+(B2.3); (A.2)+(B2.4); (A.2)+(B2.5); (A.2)+(B2.6); (A.2)+(B2.7); (A.2)+(B2.8); (A.2)+(B2.9); (A.2)+(B2.10); (A.2)+(B2.11); (A.2)+(B2.12); (A.2)+(B2.13); (A.2)+(B2.14); (A.2)+(B2.15); (A.2)+(B2.16); (A.2)+(B2.17); (A.2)+(B2.18); (A.2)+(B2.19); (A.2)+(B2.20); (A.2)+(B2.21); (A.2)+(B2.22); (A.2)+(B2.23); (A.2)+(B2.24); (A.2)+(B2.25); (A.2)+(B2.26); (A.2)+(B2.27); (A.2)+(B2.28); (A.2)+(B3.1); (A.2)+(B3.2); (A.2)+(B3.3); (A.2)+(B3.4); (A.2)+(B3.5); (A.2)+(B3.6); (A.2)+(B3.7); (A.2)+(B3.8); (A.2)+(B3.9); (A.2)+(B3.10); (A.2)+(B3.11); (A.2)+(B3.12); (A.2)+(B3.13); (A.2)+(B3.14); (A.2)+(B3.15); (A.2)+(B3.16); (A.2)+(B3.17); (A.2)+(B3.18); (A.2)+(B3.19); (A.2)+(B3.20); (A.2)+(B3.21); (A.2)+(B3.22); (A.2)+(B3.23); (A.2)+(B3.24); (A.2)+(B3.25); (A.2)+(B3.26); (A.2)+(B3.27); (A.2)+(B3.28); (A.2)+(B3.29); (A.2)+(B3.30); (A.2)+(B3.31); (A.2)+(B3.32); (A.2)+(B3.33); (A.2)+(B3.34); (A.2)+(B3.35); (A.2)+(B3.36); (A.2)+(B4.1); (A.2)+(B4.2); (A.2)+(B4.3); (A.2)+(B4.4); (A.2)+(B4.5); (A.2)+(B4.6); (A.2)+(B4.7); (A.2)+(B4.8); (A.2)+(B4.9).

(A.3)+(B1.1); (A.3)+(B1.2); (A.3)+(B1.3); (A.3)+(B1.4); (A.3)+(B1.5); (A.3)+(B1.6); (A.3)+(B1.7); (A.3)+(B1.8); (A.3)+(B1.9); (A.3)+(B1.10); (A.3)+(B1.11); (A.3)+(B1.12); (A.3)+(B1.13); (A.3)+(B1.14); (A.3)+(B1.15); (A.3)+(B1.16); (A.3)+(B1.17); (A.3)+(B1.18); (A.3)+(B1.19); (A.3)+(B1.20); (A.3)+(B1.21); (A.3)+(B1.22); (A.3)+(B1.23); (A.3)+(B2.1); (A.3)+(B2.2); (A.3)+(B2.3); (A.3)+(B2.4); (A.3)+(B2.5); (A.3)+(B2.6); (A.3)+(B2.7); (A.3)+(B2.8); (A.3)+(B2.9); (A.3)+(B2.10); (A.3)+(B2.11); (A.3)+(B2.12); (A.3)+(B2.13); (A.3)+(B2.14); (A.3)+(B2.15); (A.3)+(B2.16); (A.3)+(B2.17); (A.3)+(B2.18); (A.3)+(B2.19); (A.3)+(B2.20); (A.3)+(B2.21); (A.3)+(B2.22); (A.3)+(B2.23); (A.3)+(B2.24); (A.3)+(B2.25); (A.3)+(B2.26); (A.3)+(B2.27); (A.3)+(B2.28); (A.3)+(B3.1); (A.3)+(B3.2); (A.3)+(B3.3); (A.3)+(B3.4); (A.3)+(B3.5); (A.3)+(B3.6); (A.3)+(B3.7); (A.3)+(B3.8); (A.3)+(B3.9); (A.3)+(B3.10); (A.3)+(B3.11); (A.3)+(B3.12); (A.3)+(B3.13); (A.3)+(B3.14); (A.3)+(B3.15); (A.3)+(B3.16); (A.3)+(B3.17); (A.3)+(B3.18); (A.3)+(B3.19); (A.3)+(B3.20); (A.3)+(B3.21); (A.3)+(B3.22); (A.3)+(B3.23); (A.3)+(B3.24); (A.3)+(B3.25); (A.3)+(B3.26); (A.3)+(B3.27); (A.3)+(B3.28); (A.3)+(B3.29); (A.3)+(B3.30); (A.3)+(B3.31); (A.3)+(B3.32); (A.3)+(B3.33); (A.3)+(B3.34); (A.3)+(B3.35); (A.3)+(B3.36); (A.3)+(B4.1); (A.3)+(B4.2); (A.3)+(B4.3); (A.3)+(B4.4); (A.3)+(B4.5); (A.3)+(B4.6); (A.3)+(B4.7); (A.3)+(B4.8); (A.3)+(B4.9).

(A.4)+(B1.1); (A.4)+(B1.2); (A.4)+(B1.3); (A.4)+(B1.4); (A.4)+(B1.5); (A.4)+(B1.6); (A.4)+(B1.7); (A.4)+(B1.8); (A.4)+(B1.9); (A.4)+(B1.10); (A.4)+(B1.1); (A.4)+(B1.12); (A.4)+(B1.13); (A.4)+(B1.14); (A.4)+(B1.15); (A.4)+(B1.16); (A.4)+(B1.17); (A.4)+(B1.18); (A.4)+(B1.19); (A.4)+(B1.20); (A.4)+(B1.21); (A.4)+(B1.22); (A.4)+(B1.23); (A.4)+(B2.1); (A.4)+(B2.2); (A.4)+(B2.3); (A.4)+(B2.4); (A.4)+(B2.5); (A.4)+(B2.6); (A.4)+(B2.7); (A.4)+(B2.8); (A.4)+(B2.9); (A.4)+(B2.10); (A.4)+(B2.11); (A.4)+(B2.12); (A.4)+(B2.13); (A.4)+(B2.14); (A.4)+(B2.15); (A.4)+(B2.16); (A.4)+(B2.17); (A.4)+(B2.18); (A.4)+(B2.19); (A.4)+(B2.20); (A.4)+(B2.21); (A.4)+(B2.22); (A.4)+(B2.23); (A.4)+(B2.24); (A.4)+(B2.25); (A.4)+(B2.26); (A.4)+(B2.27); (A.4)+(B2.28); (A.4)+(B3.1); (A.4)+(B3.2); (A.4)+(B3.3); (A.4)+(B3.4); (A.4)+(B3.5); (A.4)+(B3.6); (A.4)+(B3.7); (A.4)+(B3.8); (A.4)+(B3.9); (A.4)+(B3.10); (A.4)+(B3.11); (A.4)+(B3.12); (A.4)+(B3.13); (A.4)+(B3.14); (A.4)+(B3.15); (A.4)+(B3.16); (A.4)+(B3.17); (A.4)+(B3.18); (A.4)+(B3.19); (A.4)+(B3.20); (A.4)+(B3.21); (A.4)+(B3.22); (A.4)+(B3.23); (A.4)+(B3.24); (A.4)+(B3.25); (A.4)+(B3.26); (A.4)+(B3.27); (A.4)+(B3.28); (A.4)+(B3.29); (A.4)+(B3.30); (A.4)+(B3.31); (A.4)+(B3.32); (A.4)+(B3.33); (A.4)+(B3.34); (A.4)+(B3.35); (A.4)+(B3.36); (A.4)+(B4.1); (A.4)+(B4.2); (A.4)+(B4.3); (A.4)+(B4.4); (A.4)+(B4.5); (A.4)+(B4.6); (A.4)+(B4.7); (A.4)+(B4.8); (A.4)+(B4.9).

(A.5)+(B1.1); (A.5)+(B1.2); (A.5)+(B1.3); (A.5)+(B1.4); (A.5)+(B1.5); (A.5)+(B1.6); (A.5)+(B1.7); (A.5)+(B1.8); (A.5)+(B1.9); (A.5)+(B1.10); (A.5)+(B1.11); (A.5)+(B1.12); (A.5)+(B1.13); (A.5)+(B1.14); (A.5)+(B1.15); (A.5)+(B1.16); (A.5)+(B1.17); (A.5)+(B1.18); (A.5)+(B1.19); (A.5)+(B1.20); (A.5)+(B1.21); (A.5)+(B1.22); (A.5)+(B1.23); (A.5)+(B2.1); (A.5)+(B2.2); (A.5)+(B2.3); (A.5)+(B2.4); (A.5)+(B2.5); (A.5)+(B2.6); (A.5)+(B2.7); (A.5)+(B2.8); (A.5)+(B2.9); (A.5)+(B2.10); (A.5)+(B2.11); (A.5)+(B2.12); (A.5)+(B2.13); (A.5)+(B2.14); (A.5)+(B2.15); (A.5)+(B2.16); (A.5)+(B2.17); (A.5)+(B2.18); (A.5)+(B2.19); (A.5)+(B2.20); (A.5)+(B2.21); (A.5)+(B2.22); (A.5)+(B2.23); (A.5)+(B2.24); (A.5)+(B2.25); (A.5)+(B2.26); (A.5)+(B2.27); (A.5)+(B2.28); (A.5)+(B3.1); (A.5)+(B3.2); (A.5)+(B3.3); (A.5)+(B3.4); (A.5)+(B3.5); (A.5)+(B3.6); (A.5)+(B3.7); (A.5)+(B3.8); (A.5)+(B3.9); (A.5)+(B3.10); (A.5)+(B3.11); (A.5)+(B3.12); (A.5)+(B3.13); (A.5)+(B3.14); (A.5)+(B3.15); (A.5)+(B3.16); (A.5)+(B3.17); (A.5)+(B3.18); (A.5)+(B3.19); (A.5)+(B3.20); (A.5)+(B3.21); (A.5)+(B3.22); (A.5)+(B3.23); (A.5)+(B3.24); (A.5)+(B3.25); (A.5)+(B3.26); (A.5)+(B3.27); (A.5)+(B3.28); (A.5)+(B3.29); (A.5)+(B3.30); (A.5)+(B3.31); (A.5)+(B3.32); (A.5)+(B3.33); (A.5)+(B3.34); (A.5)+(B3.35); (A.5)+(B3.36); (A.5)+(B4.1); (A.5)+(B4.2); (A.5)+(B4.3); (A.5)+(B4.4); (A.5)+(B4.5); (A.5)+(B4.6); (A.5)+(B4.7); (A.5)+(B4.8); (A.5)+(B4.9).

(A.6)+(B1.1); (A.6)+(B1.2); (A.6)+(B1.3); (A.6)+(B1.4); (A.6)+(B10.5); (A.6)+(B1.6); (A.6)+(B1.7); (A.6)+(B1.8); (A.6)+(B1.9); (A.6)+(B1.10); (A.6)+(B1.11); (A.6)+(B10.12); (A.6)+(B1.13); (A.6)+(B1.14); (A.6)+(B1.15); (A.6)+(B1.16); (A.6)+(B1.17); (A.6)+(B1.18); (A.6)+(B1.19); (A.6)+(B1.20); (A.6)+(B1.21); (A.6)+(B1.22); (A.6)+(B1.23); (A.6)+(B2.1); (A.6)+(B2.2); (A.6)+(B2.3); (A.6)+(B2.4); (A.6)+(B2.5); (A.6)+(B2.6); (A.6)+(B2.7); (A.6)+(B2.8); (A.6)+(B2.9); (A.6)+(B2.10); (A.6)+(B2.11); (A.6)+(B2.12); (A.6)+(B2.13); (A.6)+(B2.14); (A.6)+(B2.15); (A.6)+(B2.16); (A.6)+(B2.17); (A.6)+(B2.18); (A.6)+(B2.19); (A.6)+(B2.20); (A.6)+(B2.21); (A.6)+(B2.22); (A.6)+(B2.23); (A.6)+(B2.24); (A.6)+(B2.25); (A.6)+(B2.26); (A.6)+(B2.27); (A.6)+(B2.28); (A.6)+(B3.1); (A.6)+(B3.2); (A.6)+(B3.3); (A.6)+(B3.4); (A.6)+(B3.5); (A.6)+(B3.6); (A.6)+(B3.7); (A.6)+(B3.8); (A.6)+(B3.9); (A.6)+(B3.10); (A.6)+(B3.11); (A.6)+(B3.12); (A.6)+(B3.13); (A.6)+(B3.14); (A.6)+(B3.15); (A.6)+(B3.16); (A.6)+(B3.17); (A.6)+(B3.18); (A.6)+(B3.19); (A.6)+(B3.20); (A.6)+(B3.21); (A.6)+(B3.22); (A.6)+(B3.23); (A.6)+(B3.24); (A.6)+(B3.25); (A.6)+(B3.26); (A.6)+(B3.27); (A.6)+(B3.28); (A.6)+(B3.29); (A.6)+(B3.30); (A.6)+(B3.31); (A.6)+(B3.32); (A.6)+(B3.33); (A.6)+(B3.34); (A.6)+(B3.35); (A.6)+(B3.36); (A.6)+(B4.1); (A.6)+(B4.2); (A.6)+(B4.3); (A6)+(B4.4); (A.6)+(B4.5); (A.6)+(B4.6); (A.6)+(B4.7); (A.6)+(B4.8); (A.6)+(B4.9).

(A.7)+(B1.1); (A.7)+(B1.2); (A.7)+(B1.3); (A.7)+(31.4); (A.7)+(B1.5); (A.7)+(B1.6); (A.7)+(B1.7); (A.7)+(B1.8); (A.7)+(B1.9); (A.7)+(B1.10); (A.7)+(B1.11); (A.7)+(B1.12); (A.7)+(B1.13); (A.7)+(B1.14); (A.7)+(B1.15); (A.7)+(B1.16); (A.7)+(B1.17); (A.7)+(B1.18); (A.7)+(B1.19); (A.7)+(B1.20); (A.7)+(B1.21); (A.7)+(B1.22); (A.7)+(B1.23); (A.7)+(B2.1); (A.7)+(B2.2); (A.7)+(B2.3); (A.7)+(B2.4); (A.7)+(B2.5); (A.7)+(B2.6); (A.7)+(B2.7); (A.7)+(B2.8); (A.7)+(B2.9); (A.7)+(B2.10); (A.7)+(B2.11); (A.7)+(B2.12); (A.7)+(B2.13); (A.7)+(B2.14); (A.7)+(B2.15); (A.7)+(B2.16); (A.7)+(B2.17); (A.7)+(B2.18); (A.7)+(B2.19); (A.7)+(B2.20); (A.7)+(B2.21); (A.7)+(B2.22); (A.7)+(B2.23); (A.7)+(B2.24); (A.7)+(B2.25); (A.7)+(B2.26); (A.7)+(B2.27); (A.7)+(B2.28); (A.7)+(B3.1); (A.7)+(B3.2); (A.7)+(B3.3); (A.7)+(B3.4); (A.7)+(B3.5); (A.7)+(B3.6); (A.7)+(B3.7); (A.7)+(B3.8); (A.7)+(B3.9); (A.7)+(B3.10); (A.7)+(B3.11); (A.7)+(B3.12); (A.7)+(B3.13); (A.7)+(B3.14); (A.7)+(B3.15); (A.7)+(B3.16); (A.7)+(B3.17); (A.7)+(B3.18); (A.7)+(B3.19); (A.7)+(B3.20); (A.7)+(B3.21); (A.7)+(B3.22); (A.7)+(B3.23); (A.7)+(B3.24); (A.7)+(B3.25); (A.7)+(B3.26); (A.7)+(B3.27); (A.7)+(B3.28); (A.7)+(B3.29); (A.7)+(B3.30); (A.7)+(B3.31); (A.7)+(B3.32); (A.7)+(B3.33); (A.7)+(B3.34); (A.7)+(B3.35); (A.7)+(B3.36); (A.7)+(B4.1); (A.7)+(B4.2); (A.7)+(B4.3); (A.7)+(B4.4); (A.7)+(B4.5); (A.7)+(B4.6); (A.7)+(B4.7); (A.7)+(B4.8); (A.7)+(B4.9).

(A.8)+(B1.1); (A.8)+(B1.2); (A.8)+(B1.3); (A.8)+(B1.4); (A.8)+(B1.5); (A.8)+(B1.6); (A.8)+(B1.7); (A.8)+(B1.8); (A.8)+(B1.9); (A.8)+(B1.10); (A.8)+(B1.11); (A.8)+(B1.12); (A.8)+(B1.13); (A.8)+(B1.14); (A.8)+(B1.15); (A.8)+(B1.16); (A.8)+(B1.17); (A.8)+(B1.18); (A.8)+(B1.19); (A.8)+(B1.20); (A.8)+(B1.21); (A.8)+(B1.22); (A.8)+(B1.23); (A.8)+(B2.1); (A.8)+(B2.2); (A.8)+(B2.3); (A.8)+(B2.4); (A.8)+(B2.5); (A.8)+(B2.6); (A.8)+(B2.7); (A.8)+(B2.8); (A.8)+(B2.9); (A.8)+(B2.10); (A.8)+(B2.11); (A.8)+(B2.12); (A.8)+(B2.13); (A.8)+(B2.14); (A.8)+(B2.15); (A.8)+(B2.16); (A.8)+(B2.17); (A.8)+(B2.18); (A.8)+(B2.19); (A.8)+(B2.20); (A.8)+(B2.21); (A.8)+(B2.22); (A.8)+(B2.23); (A.8)+(B2.24); (A.8)+(B2.25); (A.8)+(B2.26); (A.8)+(B2.27); (A.8)+(B2.28); (A.8)+(B3.1); (A.8)+(B3.2); (A.8)+(B3.3); (A.8)+(B3.4); (A.8)+(B3.5); (A.8)+(B3.6); (A.8)+(B3.7); (A.8)+(B3.8); (A.8)+(B3.9); (A.8)+(B3.10); (A.8)+(B3.11); (A.8)+(B3.12); (A.8)+(B3.13); (A.8)+(B3.14); (A.8)+(B3.15); (A.8)+(B3.16); (A.8)+(B3.17); (A.8)+(B3.18); (A.8)+(B3.19); (A.8)+(B3.20); (A.8)+(B3.21); (A.8)+(B3.22); (A.8)+(B3.23); (A.8)+(B3.24); (A.8)+(B3.25); (A.8)+(B3.26); (A.8)+(B3.27); (A.8)+(B3.28); (A.8)+(B3.29); (A.8)+(B3.30); (A.8)+(B3.31); (A.8)+(B3.32); (A.8)+(B3.33); (A.8)+(B3.34); (A.8)+(B3.35); (A.8)+(B3.36); (A.8)+(B4.1); (A.8)+(B4.2); (A.8)+(B4.3); (A.8)+(B4.4); (A.8)+(B4.5); (A.8)+(B4.6); (A.8)+(B4.7); (A.8)+(B4.8); (A.8)+(B4.9).

(A.9)+(B1.1); (A.9)+(B1.2); (A.9)+(B1.3); (A.9)+(B1.4); (A.9)+(B1.5); (A.9)+(B1.6); (A.9)+(B1.7); (A.9)+(B1.8); (A.9)+(B1.9); (A.9)+(B1.10); (A.9)+(B1.11); (A.9)+(B1.12); (A.9)+(B1.13); (A.9)+(B1.14); (A.9)+(B1.15); (A.9)+(B1.16); (A.9)+(B1.17); (A.9)+(B1.18); (A.9)+(B1.19); (A.9)+(B1.20); (A.9)+(B1.21); (A.9)+(B1.22); (A.9)+(B1.23); (A.9)+(B2.1); (A.9)+(B2.2); (A.9)+(B2.3); (A.9)+(B2.4); (A.9)+(B2.5); (A.9)+(B2.6); (A.9)+(B2.7); (A.9)+(B2.8); (A.9)+(B2.9); (A.9)+(B2.10); (A.9)+(B2.11); (A.9)+(B2.12); (A.9)+(B2.13); (A.9)+(B2.14); (A.9)+(B2.15); (A.9)+(B2.16); (A.9)+(B2.17); (A.9)+(B2.18); (A.9)+(B2.19); (A.9)+(B2.20); (A.9)+(B2.21); (A.9)+(B2.22); (A.9)+(B2.23); (A.9)+(B2.24); (A.9)+(B2.25); (A.9)+(B2.26); (A.9)+(B2.27); (A.9)+(B2.28); (A.9)+(B3.1); (A.9)+(B3.2); (A.9)+(B3.3); (A.9)+(B3.4); (A.9)+(B3.5); (A.9)+(B3.6); (A.9)+(B3.7); (A.9)+(B3.8); (A.9)+(B3.9); (A.9)+(B3.10); (A.9)+(B3.11); (A.9)+(B3.12); (A.9)+(B3.13); (A.9)+(B3.14); (A.9)+(B3.15); (A.9)+(B3.16); (A.9)+(B3.17); (A.9)+(B3.18); (A.9)+(B3.19); (A.9)+(B3.20); (A.9)+(B3.21); (A.9)+(B3.22); (A.9)+(B3.23); (A.9)+(B3.24); (A.9)+(B3.25); (A.9)+(B3.26); (A.9)+(B3.27); (A.9)+(B3.28); (A.9)+(B3.29); (A.9)+(B3.30); (A.9)+(B3.31); (A.9)+(B3.32); (A.9)+(B3.33); (A.9)+(B3.34); (A.9)+(B3.35); (A.9)+(B3.36); (A.9)+(B4.1); (A.9)+(B4.2); (A.9)+(B4.3); (A.9)+(B4.4); (A.9)+(B4.5); (A.9)+(B4.6); (A.9)+(B4.7); (A.9)+(B4.8); (A.9)+(B4.9).

(A.10)+(B1.1); (A.10)+(B1.2); (A.10)+(B1.3); (A.10)+(B1.4); (A.10)+(B1.5); (A.10)+(B1.6); (A.10)+(B1.7); (A.10)+(B1.8); (A.10)+(B1.9); (A.10)+(B1.10); (A.10)+(B1.11); (A.10)+(B1.12); (A.10)+(B1.13); (A.10)+(B1.14); (A.10)+(B1.15); (A.10)+(B1.16); (A.10)+(B1.17); (A.10)+(B1.18); (A.10)+(B1.19); (A.10)+(B1.20); (A.10)+(B1.21); (A.10)+(B1.22); (A.10)+(B1.23); (A.10)+(B2.1); (A.10)+(B2.2); (A.10)+(B2.3); (A.10)+(B2.4); (A.10)+(B2.5); (A.10)+(B2.6); (A.10)+(B2.7); (A.10)+(B2.8); (A.10)+(B2.9); (A.10)+(B2.10); (A.10)+(B2.11); (A.10)+(B2.12); (A.10)+(B2.13); (A.10)+(B2.14); (A.10)+(B2.15); (A.10)+(B2.16); (A.10)+(B2.17); (A.10)+(B2.18); (A.10)+(B2.19); (A.10)+(B2.20); (A.10)+(B2.21); (A.10)+(B2.22); (A.10)+(B2.23); (A.10)+(B2.24); (A.10)+(B2.25); (A.10)+(B2.26); (A.10)+(B2.27); (A.10)+(B2.28); (A.10)+(B3.1); (A.10)+(B3.2); (A.10)+(B3.3); (A.10)+(B3.4); (A.10)+(B3.5); (A.10)+(B3.6); (A.10)+(B3.7); (A.10)+(B3.8); (A.10)+(B3.9); (A.10)+(B3.10); (A.10)+(B3.11); (A.10)+(B3.12); (A.10)+(B3.13); (A.10)+(B3.14); (A.10)+(B3.15); (A.10)+(B3.16); (A.10)+(B3.17); (A.10)+(B3.18); (A.10)+(B3.19); (A.10)+(B3.20); (A.10)+(B3.21); (A.10)+(B3.22); (A.10)+(B3.23); (A.10)+(B3.24); (A.10)+(B3.25); (A.10)+(B3.26); (A.10)+(B3.27); (A.10)+(B3.28); (A.10)+(B3.29); (A.10)+(B3.30); (A.10)+(B3.31); (A.10)+(B3.32); (A.10)+(B3.33); (A.10)+(B3.34); (A.10)+(B3.35); (A.10)+(B3.36); (A.10)+(B4.1); (A.10)+(B4.2); (A.10)+(B4.3); (A.10)+(B4.4); (A.10)+(B4.5); (A.10)+(B4.6); (A.10)+(B4.7); (A.10)+(B4.8); (A.10)+(B4.9).

(A.11)+(B1.1); (A.11)+(B1.2); (A.11)+(B1.3); (A.11)+(B1.4); (A.11)+(B1.5); (A.11)+(B1.6); (A.11)+(B1.7); (A.11)+(B1.8); (A.11)+(B1.9); (A.11)+(B1.10); (A.11)+(B1.11); (A.1.11)+(B1.12); (A.11)+(B1.13); (A.1)+(B1.14); (A.11)+(B1.15); (A.11)+(B1.16); (A.11)+(B1.17); (A.1)+(B1.18); (A.11)+(B1.19); (A.11)+(B1.20); (A.1)+(B1.21); (A.1)+(B1.22); (A.11)+(B1.23); (A.11)+(B2.1); (A.11)+(B2.2); (A.11)+(B2.3); (A.11)+(B2.4); (A.11)+(B2.5); (A.11)+(B2.6); (A.11)+(B2.7); (A.11)+(B2.8); (A.11)+(B2.9); (A.11)+(B2.10); (A.11)+(B2.11); (A.11)+(B2.12); (A.11)+(B2.13); (A.11)+(B2.14); (A.11)+(B2.15); (A.11)+(B2.16); (A.11)+(B2.17); (A.11)+(B2.18); (A.11)+(B2.19); (A.11)+(B2.20); (A.11)+(B2.21); (A.11)+(B2.22); (A.11)+(B2.23); (A.11)+(B2.24); (A.11)+(B2.25); (A.11)+(B2.26); (A.11)+(B2.27); (A.11)+(B2.28); (A.11)+(B3.1); (A.11)+(B3.2); (A.11)+(B3.3); (A.11)+(B3.4); (A.11)+(B3.5); (A.11)+(B3.6); (A.11)+(B3.7); (A.11)+(B3.8); (A.11)+(B3.9); (A.11)+(B3.10); (A.11)+(B3.11); (A.11)+(B3.12); (A.11)+(B3.13); (A.11)+(B3.14); (A.1)+(B3.15); (A.11)+(B3.16); (A.11)+(B3.17); (A.11)+(B3.18); (A.11)+(B3.19); (A.11)+(B3.20); (A.11)+(B3.21); (A.11)+(B3.22); (A.11)+(B3.23); (A.11)+(B3.24); (A.11)+(B3.25); (A.11)+(B3.26); (A.11)+(B3.27); (A.11)+(B3.28); (A.11)+(B3.29); (A.11)+(B3.30); (A.11)+(B3.31); (A.11)+(B3.32); (A.11)+(B3.33); (A.11)+(B3.34); (A.11)+(B3.35); (A.11)+(B3.36); (A.11)+(B4.1); (A.11)+(B4.2); (A.11)+(B4.3); (A.11)+(B4.4); (A.11)+(B4.5); (A.11)+(B4.6); (A.11)+(B4.7); (A.11)+(B4.8); (A.11)+(B4.9).

(A.12)+(B1.1); (A.12)+(B1.2); (A.12)+(B1.3); (A.12)+(B1.4); (A.12)+(B1.5); (A.12)+(B1.6); (A.12)+(B1.7); (A.12)+(B1.8); (A.12)+(B1.9); (A.12)+(B1.10); (A.12)+(B1.11); (A.12)+(B1.12); (A.12)+(B1.13); (A.12)+(B1.14); (A.12)+(B1.15); (A.12)+(B1.16); (A.12)+(B1.17); (A.12)+(B1.18); (A.12)+(B1.19); (A.12)+(B1.20); (A.12)+(B1.21); (A.12)+(B1.22); (A.12)+(B1.23); (A.12)+(B2.1); (A.12)+(B2.2); (A.12)+(B2.3); (A.12)+(B2.4); (A.12)+(B2.5); (A.12)+(B2.6); (A.12)+(B2.7); (A.12)+(B2.8); (A.12)+(B2.9); (A.12)+(B2.10); (A.12)+(B2.11); (A.12)+(B2.12); (A.12)+(B2.13); (A.12)+(B2.14); (A.12)+(B2.15); (A.12)+(B2.16); (A.12)+(B2.17); (A.12)+(B2.18); (A.12)+(B2.19); (A.12)+(B2.20); (A.12)+(B2.21); (A.12)+(B2.22); (A.12)+(B2.23); (A.12)+(B2.24); (A.12)+(B2.25); (A.12)+(B2.26); (A.12)+(B2.27); (A.12)+(B2.28); (A.12)+(B3.1); (A.12)+(B3.2); (A.12)+(B3.3); (A.12)+(B3.4); (A.12)+(B3.5); (A.12)+(B3.6); (A.12)+(B3.7); (A.12)+(B3.8); (A.12)+(B3.9); (A.12)+(B3.10); (A.12)+(B3.11); (A.12)+(B3.12); (A.12)+(B3.13); (A.12)+(B3.14); (A.12)+(B3.15); (A.12)+(B3.16); (A.12)+(B3.17); (A.12)+(B3.18); (A.12)+(B3.19); (A.12)+(B3.20); (A.12)+(B3.21); (A.12)+(B3.22); (A.12)+(B3.23); (A.12)+(B3.24); (A.12)+(B3.25); (A.12)+(B3.26); (A.12)+(B3.27); (A.12)+(B3.28); (A.12)+(B3.29); (A.12)+(B3.30); (A.12)+(B3.31); (A.12)+(B3.32); (A.12)+(B3.33); (A.12)+(B3.34); (A.12)+(B3.35); (A.12)+(B3.36); (A.12)+(B4.1); (A.12)+(B4.2); (A.12)+(B4.3); (A.12)+(B4.4); (A.12)+(B4.5); (A.12)+(B4.6); (A.12)+(B4.7); (A.12)+(B4.8); (A.12)+(B4.9).

(A.13)+(B1.1); (A.13)+(B1.2); (A.13)+(B1.3); (A.13)+(B1.4); (A.13)+(B1.5); (A.13)+(B1.6); (A.13)+(B1.7); (A.13)+(B1.8); (A.13)+(B1.9); (A.13)+(B1.10); (A.13)+(B1.11); (A.13)+(B1.12); (A.13)+(B1.13); (A.13)+(B1.14); (A.13)+(B1.15); (A.13)+(B1.16); (A.13)+(B1.17); (A.13)+(B1.18); (A.13)+(B1.19); (A.13)+(B1.20); (A.13)+(B1.21); (A.13)+(B1.22); (A.13)+(B1.23); (A.13)+(B2.1); (A.13)+(B2.2); (A.13)+(B2.3); (A.13)+(B2.4); (A.13)+(B2.5); (A.13)+(B2.6); (A.13)+(B2.7); (A.13)+(B2.8); (A.13)+(B2.9); (A.13)+(B2.10); (A.13)+(B2.11); (A.13)+(B2.12); (A.13)+(B2.13); (A.13)+(B2.14); (A.13)+(B2.15); (A.13)+(B2.16); (A.13)+(B2.17); (A.13)+(B2.18); (A.13)+(B2.19); (A.13)+(B2.20); (A.13)+(B2.21); (A.13)+(B2.22); (A.13)+(B2.23); (A.13)+(B2.24); (A.13)+(B2.25); (A.13)+(B2.26); (A.13)+(B2.27); (A.13)+(B2.28); (A.13)+(B3.1); (A.13)+(B3.2); (A.13)+(B3.3); (A.13)+(B3.4); (A.13)+(B3.5); (A.13)+(B3.6); (A.13)+(B3.7); (A.13)+(B3.8); (A.13)+(B3.9); (A.13)+(B3.10); (A.13)+(B3.11); (A.13)+(B3.12); (A.13)+(B3.13); (A.13)+(B3.14); (A.13)+(B3.15); (A.13)+(B3.16); (A.13)+(B3.17); (A.13)+(B3.18); (A.13)+(B3.19); (A.13)+(B3.20); (A.13)+(B3.21); (A.13)+(B3.22); (A.13)+(B3.23); (A.13)+(B3.24); (A.13)+(B3.25); (A.13)+(B3.26); (A.13)+(B3.27); (A.13)+(B3.28); (A.13)+(B3.29); (A.13)+(B3.30); (A.13)+(B3.31); (A.13)+(B3.32); (A.13)+(B3.33); (A.13)+(B3.34); (A.13)+(B3.35); (A.13)+(B3.36); (A.13)+(B4.1); (A.13)+(B4.2); (A.13)+(B4.3); (A.13)+(B4.4); (A.13)+(B4.5); (A.13)+(B4.6); (A.13)+(B4.7); (A.13)+(B4.8); (A.13)+(B4.9).

(A.14)+(B1.1); (A.14)+(B1.2); (A.14)+(B1.3); (A.14)+(B1.4); (A.14)+(B1.5); (A.14)+(B1.6); (A.14)+(B1.7); (A.14)+(B1.8); (A.14)+(B1.9); (A.14)+(B1.10); (A.14)+(B1.11); (A.14)+(B1.12); (A.14)+(B1.13); (A.14)+(B1.14); (A.14)+(B1.15); (A.14)+(B1.16); (A.14)+(B1.17); (A.14)+(B1.18); (A.14)+(B1.19); (A.14)+(B1.20); (A.14)+(B1.21); (A.14)+(B1.22); (A.14)+(B1.23); (A.14)+(B2.1); (A.14)+(B2.2); (A.14)+(B2.3); (A.14)+(B2.4); (A.14)+(B2.5); (A.14)+(B2.6); (A.14)+(B2.7); (A.14)+(B2.8); (A.14)+(B2.9); (A.14)+(B2.10); (A.14)+(B2.11); (A.14)+(B2.12); (A.14)+(B2.13); (A.14)+(B2.14); (A.14)+(B2.15); (A.14)+(B2.16); (A.14)+(B2.17); (A.14)+(B2.18); (A.14)+(B2.19); (A.14)+(B2.20); (A.14)+(B2.21); (A.14)+(B2.22); (A.14)+(B2.23); (A.14)+(B2.24); (A.14)+(B2.25); (A.14)+(B2.26); (A.14)+(B2.27); (A.14)+(B2.28); (A.14)+(B3.1); (A.14)+(B3.2); (A.14)+(B3.3); (A.14)+(B3.4); (A.14)+(B3.5); (A.14)+(B3.6); (A.14)+(B3.7); (A.14)+(B3.8); (A.14)+(B3.9); (A.14)+(B3.10); (A.14)+(B3.11); (A.14)+(B3.12); (A.14)+(B3.13); (A.14)+(B3.14); (A.14)+(B3.15); (A.14)+(B3.16); (A.14)+(B3.17); (A.14)+(B3.18); (A.14)+(B3.19); (A.14)+(B3.20); (A.14)+(B3.21); (A.14)+(B3.22); (A.14)+(B3.23); (A.14)+(B3.24); (A.14)+(B3.25); (A.14)+(B3.26); (A.14)+(B3.27); (A.14)+(B3.28); (A.14)+(B3.29); (A.14)+(B3.30); (A.14)+(B3.31); (A.14)+(B3.32); (A.14)+(B3.33); (A.14)+(B3.34); (A.14)+(B3.35); (A.14)+(B3.36); (A.14)+(B4.1); (A.14)+(B4.2); (A.14)+(B4.3); (A.14)+(B4.4); (A.14)+(B4.5); (A.14)+(B4.6); (A.14)+(B4.7); (A.14)+(B4.8); (A.14)+(B4.9).

(A.15)+(B1.1); (A.15)+(B1.2); (A.15)+(B1.3); (A.15)+(B1.4); (A.15)+(B1.5); (A.15)+(B1.6); (A.15)+(B1.7); (A.15)+(B1.8); (A.15)+(B1.9); (A.15)+(B1.10); (A.15)+(B1.11); (A.15)+(B1.12); (A.15)+(B1.13); (A.15)+(B1.14); (A.15)+(B1.15); (A.15)+(B1.16); (A.15)+(B1.17); (A.15)+(B1.18); (A.15)+(B1.19); (A.15)+(B1.20); (A.15)+(B1.21); (A.15)+(B1.22); (A.15)+(B1.23); (A.15)+(B2.1); (A.15)+(B2.2); (A.15)+(B2.3); (A.15)+(B2.4); (A.15)+(B2.5); (A.15)+(B2.6); (A.15)+(B2.7); (A.15)+(B2.8); (A.15)+(B2.9); (A.15)+(B2.10); (A.15)+(B2.11); (A.15)+(B2.12); (A.15)+(B2.13); (A.15)+(B2.14); (A.15)+(B2.15); (A.15)+(B2.16); (A.15)+(B2.17); (A.15)+(B2.18); (A.15)+(B2.19); (A.15)+(B2.20); (A.15)+(B2.21); (A.15)+(B2.22); (A.15)+(B2.23); (A.15)+(B2.24); (A.15)+(B2.25); (A.15)+(B2.26); (A.15)+(B2.27); (A.15)+(B2.28); (A.15)+(B3.1); (A.15)+(B3.2); (A.15)+(B3.3); (A.15)+(B3.4); (A.15)+(B3.5); (A.15)+(B3.6); (A.15)+(B3.7); (A.15)+(B3.8); (A.15)+(B3.9); (A.15)+(B3.10); (A.15)+(B3.11); (A.15)+(B3.12); (A.15)+(B3.13); (A.15)+(B3.14); (A.15)+(B3.15); (A.15)+(B3.16); (A.15)+(B3.17); (A.15)+(B3.18); (A.15)+(B3.19); (A.15)+(B3.20); (A.15)+(B3.21); (A.15)+(B3.22); (A.15)+(B3.23); (A.15)+(B3.24); (A.15)+(B3.25); (A.15)+(B3.26); (A.15)+(B3.27); (A.15)+(B3.28); (A.15)+(B3.29); (A.15)+(B3.30); (A.15)+(B3.31); (A.15)+(B3.32); (A.15)+(B3.33); (A.15)+(B3.34); (A.15)+(B3.35); (A.15)+(B3.36); (A.15)+(B4.1); (A.15)+(B4.2); (A.15)+(B4.3); (A.15)+(B4.4); (A.15)+(B4.5); (A.15)+(B4.6); (A.15)+(B4.7); (A.15)+(B4.8); (A.15)+(B4.9).

(A.16)+(B1.1); (A.16)+(B1.2); (A.16)+(B1.3); (A.16)+(B1.4); (A.16)+(B1.5); (A.16)+(B1.6); (A.16)+(B1.7); (A.16)+(B1.8); (A.16)+(B1.9); (A.16)+(B1.10); (A.16)+(B1.11); (A.16)+(B1.12); (A.16)+(B1.13); (A.16)+(B1.14); (A.16)+(B1.15); (A.16)+(B1.16); (A.16)+(B1.17); (A.16)+(B1.18); (A.16)+(B1.19); (A.16)+(B1.20); (A.16)+(B1.21); (A.16)+(B1.22); (A.16)+(B1.23); (A.16)+(B2.1); (A.16)+(B2.2); (A.16)+(B2.3); (A.16)+(B2.4); (A.16)+(B2.5); (A.16)+(B2.6); (A.16)+(B2.7); (A.16)+(B2.8); (A.16)+(B2.9); (A.16)+(B2.10); (A.16)+(B2.11); (A.16)+(B2.12); (A.16)+(B2.13); (A.16)+(B2.14); (A.16)+(B2.15); (A.16)+(B2.16); (A.16)+(B2.17); (A.16)+(B2.18); (A.16)+(B2.19); (A.16)+(B2.20); (A.16)+(B2.21); (A.16)+(B2.22); (A.16)+(B2.23); (A.16)+(B2.24); (A.16)+(B2.25); (A.16)+(B2.26); (A.16)+(B2.27); (A.16)+(B2.28); (A.16)+(B3.1); (A.16)+(B3.2); (A.16)+(B3.3); (A.16)+(B3.4); (A.16)+(B3.5); (A.16)+(B3.6); (A.16)+(B3.7); (A.16)+(B3.8); (A.16)+(B3.9); (A.16)+(B3.10); (A.16)+(B3.11); (A.16)+(B3.12); (A.16)+(B3.13); (A.16)+(B3.14); (A.16)+(B3.15); (A.16)+(B3.16); (A.16)+(B3.17); (A.16)+(B3.18); (A.16)+(B3.19); (A.16)+(B3.20); (A.16)+(B3.21); (A.16)+(B3.22); (A.16)+(B3.23); (A.16)+(B3.24); (A.16)+(B3.25); (A.16)+(B3.26); (A.16)+(B3.27); (A.16)+(B3.28); (A.16)+(B3.29); (A.16)+(B3.30); (A.16)+(B3.31); (A.16)+(B3.32); (A.16)+(B3.33); (A.16)+(B3.34); (A.16)+(B3.35); (A.16)+(B3.36); (A.16)+(B4.1); (A.16)+(B4.2); (A.16)+(B4.3); (A.16)+(B4.4); (A.16)+(B4.5); (A.16)+(B4.6); (A.16)+(B4.7); (A.16)+(B4.8); (A.16)+(B4.9).

(A.17)+(B1.1); (A.17)+(B1.2); (A.17)+(B1.3); (A.17)+(B1.4); (A.17)+(B1.5); (A.17)+(B1.6); (A.17)+(B1.7); (A.17)+(B1.8); (A.17)+(B1.9); (A.17)+(B1.10); (A.17)+(B1.11); (A.17)+(B1.12); (A.17)+(B1.13); (A.17)+(B1.14); (A.17)+(B1.15); (A.17)+(B1.16); (A.17)+(B1.17); (A.17)+(B1.18); (A.17)+(B1.19); (A.17)+(B1.20); (A.17)+(B1.21); (A.17)+(B1.22); (A.17)+(B1.23); (A.17)+(B2.1); (A.17)+(B2.2); (A.17)+(B2.3); (A.17)+(B2.4); (A.17)+(B2.5); (A.17)+(B2.6); (A.17)+(B2.7); (A.17)+(B2.8); (A.17)+(B2.9); (A.17)+(B2.10); (A.17)+(B2.11); (A.17)+(B2.12); (A.17)+(B2.13); (A.17)+(B2.14); (A.17)+(B2.15); (A.17)+(B2.16); (A.17)+(B2.17); (A.17)+(B2.18); (A.17)+(B2.19); (A.17)+(B2.20); (A.17)+(B2.21); (A.17)+(B2.22); (A.17)+(B2.23); (A.17)+(B2.24); (A.17)+(B2.25); (A.17)+(B2.26); (A.17)+(B2.27); (A.17)+(B2.28); (A.17)+(B3.1); (A.17)+(B3.2); (A.17)+(B3.3); (A.17)+(B3.4); (A.17)+(B3.5); (A.17)+(B3.6); (A.17)+(B3.7); (A.17)+(B3.8); (A.17)+(B3.9); (A.17)+(B3.10); (A.17)+(B3.11); (A.17)+(B3.12); (A.17)+(B3.13); (A.17)+(B3.14); (A.17)+(B3.15); (A.17)+(B3.16); (A.17)+(B3.17); (A.17)+(B3.18); (A.17)+(B3.19); (A.17)+(B3.20); (A.17)+(B3.21); (A.17)+(B3.22); (A.17)+(B3.23); (A.17)+(B3.24); (A.17)+(B3.25); (A.17)+(B3.26); (A.17)+(B3.27); (A.17)+(B3.28); (A.17)+(B3.29); (A.17)+(B3.30); (A.17)+(B3.31); (A.17)+(B3.32); (A.17)+(B3.33); (A.17)+(B3.34); (A.17)+(B3.35); (A.17)+(B3.36); (A.17)+(B4.1); (A.17)+(B4.2); (A.17)+(B4.3); (A.17)+(B4.4); (A.17)+(B4.5); (A.17)+(B4.6); (A.17)+(B4.7); (A.17)+(B4.8); (A.17)+(B4.9).

(A.18)+(B1.1); (A.18)+(B1.2); (A.18)+(B1.3); (A.18)+(B1.4); (A.18)+(B1.5); (A.18)+(B1.6); (A.18)+(B1.7); (A.18)+(B1.8); (A.18)+(B1.9); (A.18)+(B1.10); (A.18)+(B1.11); (A.18)+(B1.12); (A.18)+(B1.13); (A.18)+(B1.14); (A.18)+(B1.15); (A.18)+(B1.16); (A.18)+(B1.17); (A.18)+(B1.18); (A.18)+(B1.19); (A.18)+(B1.20); (A.18)+(B1.21); (A.18)+(B1.22); (A.18)+(B1.23); (A.18)+(B2.1); (A.18)+(B2.2); (A.18)+(B2.3); (A.18)+(B2.4); (A.18)+(B2.5); (A.18)+(B2.6); (A.18)+(B2.7); (A.18)+(B2.8); (A.18)+(B2.9); (A.18)+(B2.10); (A.18)+(B2.11); (A.18)+(B2.12); (A.18)+(B2.13); (A.18)+(B2.14); (A.18)+(B2.15); (A.18)+(B2.16); (A.18)+(B2.17); (A.18)+(B2.18); (A.18)+(B2.19); (A.18)+(B2.20); (A.18)+(B2.21); (A.18)+(B2.22); (A.18)+(B2.23); (A.18)+(B2.24); (A.18)+(B2.25); (A.18)+(B2.26); (A.18)+(B2.27); (A.18)+(B2.28); (A.18)+(B3.1); (A.18)+(B3.2); (A.18)+(B3.3); (A.18)+(B3.4); (A.18)+(B3.5); (A.18)+(B3.6); (A.18)+(B3.7); (A.18)+(B3.8); (A.18)+(B3.9); (A.18)+(B3.10); (A.18)+(B3.11); (A.18)+(B3.12); (A.18)+(B3.13); (A.18)+(B3.14); (A.18)+(B3.15); (A.18)+(B3.16); (A.18)+(B3.17); (A.18)+(B3.18); (A.18)+(B3.19); (A.18)+(B3.20); (A.18)+(B3.21); (A.18)+(B3.22); (A.18)+(B3.23); (A.18)+(B3.24); (A.18)+(B3.25); (A.18)+(B3.26); (A.18)+(B3.27); (A.18)+(B3.28); (A.18)+(B3.29); (A.18)+(B3.30); (A.18)+(B3.31); (A.18)+(B3.32); (A.18)+(B3.33); (A.18)+(B3.34); (A.18)+(B3.35); (A.18)+(B3.36); (A.18)+(B4.1); (A.18)+(B4.2); (A.18)+(B4.3); (A.18)+(B4.4); (A.18)+(B4.5); (A.18)+(B4.6); (A.18)+(B4.7); (A.18)+(B4.8); (A.18)+(B4.9).

For all of these interesting (A)+(B) combinations, the addition of the safener mefenpyr-diethyl (S1-1) is particularly preferred. In this case, instead of the compound (A.1), (A.2), (A.3), (A.4), (A.5), (A.6), (A.7), (A.8), (A.9), (A.10), (A.11), (A.12), (A.13), (A.14), (A.15), (A.16), (A.17) or (A.18), the combinations in each case comprise the corresponding two-compound combinations: (A.1)+(S1-1), (A.2)+(S1-1), (A.3)+(S1-1), (A.4)+(S1-1), (A.5)+(S1-1), (A.6)+(S1-1), (A.7)+(S1-1), (A.8)+(S1-1), (A.9)+(S1-1), (A.10)+(S1-1), (A.11)+(S1-1), (A.12)+(S1-1), (A.13)+(S1-1), (A.14)+(S1-1), (A.15)+(S1-1), (A.16)+(S1-1), (A.17)+(S1-1), (A.18)+(S1-1).

For all of these interesting (A)+(B) combinations, the addition of the safener cloquintocet-mexyl (S2-2) is particularly preferred. In this case, instead of the compound (A.1), (A.2), (A.3), (A.4), (A.5), (A.6), (A.7), (A.8), (A.9), (A.10), (A.11), (A.12), (A.13), (A.14), (A.15), (A.16), (A.17) or (A.18), the combinations in each case comprise the corresponding two-compound combinations: (A.1)+(S2-2), (A.2)+(S2-2), (A.3)+(S2-2), (A.4)+(S2-2), (A.5)+(S2-2), (A.6)+(S2-2), (A.7)+(S2-2), (A.8)+(S2-2), (A.9)+(S2-2), (A.10)+(S2-2), (A.11)+(S2-2), (A.12)+(S2-2), (A.13)+(S2-2), (A.14)+(S2-2), (A.15)+(S2-2), (A.16)+(S2-2), (A.17)+(S2-2), (A.18)+(S2-2)

For all of these interesting (A)+(B) combinations, the addition of the safener isoxadifen-ethyl (S1-9) is particularly preferred. In this case, instead of the compound (A.1), (A.2), (A.3), (A.4), (A.5), (A.6), (A.7), (A.8), (A.9), (A.10), (A.11), (A.12), (A.13), (A.14), (A.15), (A.16), (A.17) or (A.18), the combinations in each case comprise the corresponding two-compound combinations: (A.1)+(S1-9), (A.2)+(S1-9), (A.3)+(S1-9), (A.4)+(S1-9), (A.5)+(S1-9), (A.6)+(S1-9), (A.7)+(S1-9), (A.8)+(S1-9), (A.9)+(S1-9), (A.10)+(S1-9), (A.11)+(S1-9), (A.12)+(S1-9), (A.13)+(S1-9), (A.14)+(S1-9), (A.15)+(S1-9), (A.16)+(S1-9), (A.17)+(S1-9), (A.18)+(S1-9).

For all of these interesting (A)+(B) combinations, the addition of the safener fenchlorazole-ethyl (S1-6) is particularly preferred. In this case, instead of the compound (A.1), (A.2), (A.3), (A.4), (A.5), (A.6), (A.7), (A.8), (A.9), (A.10), (A.11), (A.12), (A.13), (A.14), (A.15), (A.16), (A.17) or (A.18), the combinations in each case comprise the corresponding two-compound combinations: (A.1)+(S1-6), (A.2)+(S1-6), (A.3)+(S1-6), (A.4)+(S1-6), (A.5)+(S1-6), (A.6)+(S1-6), (A.7)+(S1-6), (A.8)+(S1-6), (A.9)+(S1-6), (A.10)+(S1-6), (A.11)+(S1-6), (A.12)+(S1-6), (A.13)+(S1-6), (A.14)+(S1-6), (A.15)+(S1-6), (A.16)+(S1-6), (A.17)+(S1-6), (A.18)+(S1-6).

For all of these interesting (A)+(B) combinations, the addition of the safener N-cyclopropyl-4-[(2-methoxybenzoyl)sulfamoyl]benzamide (see above, S3-1) is particularly preferred. In this case, instead of the compound (A.1), (A.2), (A.3), (A.4), (A.5), (A.6), (A.7), (A.8), (A.9), (A.10), (A.11), (A.12), (A.13), (A.14), (A.15), (A.16), (A.17) or (A.18), the combinations in each case comprise the corresponding two-compound combinations: (A.1)+(S3-1), (A.2)+(S3-1), (A.3)+(S3-1), (A.4)+(S3-1), (A.5)+(S3-1), (A.6)+(S3-1), (A.7)+(S3-1), (A.8)+(S3-1), (A.9)+(S3-1), (A.10)+(S3-1), (A.11)+(S3-1), (A.12)+(S3-1), (A.13)+(S3-1), (A.14)+(S3-1), (A.15)+(S3-1), (A.16)+(S3-1), (A.17)+(S3-1), (A.18)+(S3-1).

It may be expedient to combine one or more herbicides (A) with one or else a plurality of herbicides (B), for example one herbicide (A) with a plurality of herbicides (B).

Furthermore, the herbicide combinations according to the invention may be applied together with other agrochemically active compounds, for example from the group of the safeners, fungicides, herbicides, insecticides and plant growth regulators, or with additives customary in crop protection and formulation auxiliaries. Additives are, for example, fertilizers and colorants. In each case, the ranges of application rates and the ratios of application rates mentioned above are preferred.

The combinations according to the invention (=herbicidal compositions) have excellent herbicidal activity against a broad spectrum of economically important mono- and dicotyledonous harmful plants. In this context, it is immaterial whether the substances are applied pre-sowing, pre-emergence or post-emergence. Preference is given to the application by the post-emergence method using the compounds of group (B1) or (B2).

By way of example, some representatives of the mono- and dicotyledonous weed flora may be mentioned which can be controlled by the compounds according to the invention; however, this list is not to be understood as meaning a limitation to certain species.

Among the monocotyledonous grass species, the compounds act efficiently, for example, both against self-sown cereals, such as wheat, barley, rye and triticale, and, for example, against Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp., such as Bromus catharticus, Bromus secalinus, Bromus erectus, Bromus tectorum and Bromus japonicus, and Cyperus species from the annual group and, from among the perennial species, Agropyron, Cynodon, Imperata and Sorghum, and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., Papaver rhoeas spp., Centaurea spp. among the annual species, and also Convolvulus, Cirsium, Rumex and Artemisia spp. among the perennial weeds.

If the herbicide combinations according to the invention are applied to the soil surface prior to germination, then the weed seedlings are either prevented completely from emerging, or the weeds grow until they have reached the cotyledon stage but then their growth stops, and, eventually, after three to four weeks have elapsed, they die completely.

If the active compounds are applied post-emergence to the green parts of the plants, growth also stops drastically a very short time after the treatment and the weed plants remain at the developmental stage of the point in time of application, or they die completely after a certain time, so that in this manner competition by the weeds, which is harmful to the crop plants, is eliminated at a very early point in time and in a sustained manner.

The herbicidal compositions according to the invention have a rapid and long-lasting herbicidal action. The shower resistance of the active compounds in the combinations according to the invention is generally favorable. By using the active compound combination according to the invention, it is possible to reduce the required application rate of the active compounds considerably.

If, in a preferred embodiment, herbicides of type (A)+(B) are applied jointly, superadditive (=synergistic) effects are observed in a preferred embodiment. Here, the activity in the combinations is stronger than the expected sum of the activities of the individual herbicides used. The synergistic effects permit a reduction of the application rate, the control of a broader spectrum of broad-leaved weeds and weed grasses, a more rapid onset of the herbicidal action, a longer duration of action, a better control of the harmful plants with only one or few applications and a widening of the possible period of use. In some cases, the use of compositions also reduces the amount of harmful ingredients, such as nitrogen or oleic acid, and their incorporation into the soil.

The combinations according to the invention (=herbicidal composition) have excellent herbicidal activity against a broad spectrum of economically important monocotyledonous and dicotyledonous harmful plants including species resistant against herbicidally active compounds such as glyphosate, glufosinate, atrazine or imidazolinone herbicides.

Although the combinations according to the invention have an excellent herbicidal activity against monocotyledonous and dicotyledonous harmful plants, the crop plants are not damaged at all, or only to a negligible extent. This applies in particular when herbicides of group (A) are used with the safeners.

In addition, the compositions according to the invention in some cases have outstanding growth-regulating properties in crop plants. They engage in the plant metabolism in a regulating manner and can thus be employed for the targeted control of plant constituents and for facilitating harvesting, for example by provoking desiccation and stunted growth. Furthermore, they are also suitable for generally regulating and inhibiting undesirable vegetative growth, without destroying the plants in the process. Inhibition of vegetative growth plays an important role in many monocotyledonous and dicotyledonous crops because lodging can be reduced hereby, or prevented completely.

By virtue of their herbicidal and plant growth-regulatory properties, the compositions according to the invention can be employed for controlling harmful plants in crop plants which are genetically modified or have been obtained by mutation/selection. These crop plants generally have particularly advantageous properties, for example resistance to herbicidal compositions or plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, for example, transgenic plants having an increased starch content or a modified quality of the starch or those having a different fatty acid composition of the harvested product are known. Conventional ways for preparing novel plants which have modified properties compared to known plants comprise, for example, traditional breeding methods and the generation of mutants (see, for example, U.S. Pat. No. 5,162,602; U.S. Pat. No. 4,761,373; U.S. Pat. No. 4,443,971). Alternatively, novel plants having modified properties can be generated with the aid of genetic engineering methods (see, for example, EP-A-0 221 044, EP-A-0 131 624). For example, there have been described several cases of
genetically engineered changes in crop plants in order to modify the starch synthesized in the plants (for example WO 92/11376, WO 92/14827, WO 91/19806),
transgenic crop plants which are resistant to other herbicides, for example sulfonylureas (EP-A-0 257 993, U.S. Pat. No. 5,013,659), to glyphosate (Round-up Ready© cultivars), to glufosinate (LibertyLink© cultivars) or to imidazolinones,
transgenic oilseed rape plants, for example imidazolinone-resistant oilseed rape cultivars, Roundup Ready© oilseed rape (RR-oilseed rape) or LibertyLink© oilseed rape (LL-oilseed rape),
transgenic crop plants having the ability to produce Bacillus thuringiensis toxins (Bt toxins) which impart resistance to certain pests to the plants (EP-A-0 142 924, EP-A-0 193 259),
transgenic crop plants having a modified fatty acid composition (WO 91/13972).

Numerous molecular biological techniques which allow the preparation of novel transgenic plants having modified properties are known in principle; see, for example, Sambrook et al., 1989, Molecular Cloning, A Laboratory Manual, 2nd Ed., Cold Spring Harbor Laboratory Press, Cold Spring Harbor, N.Y.; or Winnacker “Gene und Klone” [Genes and Clones], VCH Weinheim, 2nd Edition 1996, or Christou, “Trends in Plant Science” 1 (1996) 423-431).

In order to carry out such genetic engineering manipulations, it is possible to introduce nucleic acid molecules into plasmids which allow a mutagenesis or a change in the sequence to occur by recombination of DNA sequences. Using the abovementioned standard processes it is possible, for example, to exchange bases, to remove partial sequences or to add natural or synthetic sequences. To link the DNA fragments with each other, it is possible to attach adaptors or linkers to the fragments.

Plant cells having a reduced activity of a gene product can be prepared, for example, by expressing at least one appropriate antisense-RNA, a sense-RNA to achieve a cosuppression effect, or by expressing at least one appropriately constructed ribozyme which specifically cleaves transcripts of the abovementioned gene product.

To this end it is possible to employ both DNA molecules which comprise the entire coding sequence of a gene product including any flanking sequences that may be present, and DNA molecules which comprise only parts of the coding sequence, it being necessary for these parts to be long enough to cause an antisense effect in the cells. It is also possible to use DNA sequences which have a high degree of homology to the coding sequences of a gene product but which are not entirely identical.

When expressing nucleic acid molecules in plants, the synthesized protein can be localized in any desired compartment of the plant cell. However, to achieve localization in a certain compartment, it is, for example, possible to link the coding region with DNA sequences which ensure localization in a certain compartment. Such sequences are known to the person skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated to whole plants using known techniques. The transgenic plants can in principle be plants of any desired plant species, i.e. both monocotyledonous and dicotyledonous plants. In this manner, it is possible to obtain transgenic plants which have modified properties by overexpression, suppression or inhibition of homologous (=natural) genes or gene sequences or by expression of heterologous (=foreign) genes or gene sequences.

Furthermore, the present invention also provides a method for controlling unwanted vegetation (for example harmful plants), preferably in crop plants such as cereals (for example wheat, barley, rye, oats, crossbreeds thereof, such as triticale, rice, corn, millet), sugar beet, sugar cane, oilseed rape, cotton and soybean, particularly preferably in monocotyledonous crops such as cereals, for example wheat, barley, rye, oats, crossbreeds thereof, such as triticale, rice, corn and millet, or in dicotyledonous crops, which method comprises applying one or more herbicides of type (A) and one or more herbicides of type (B) jointly or separately, for example by the pre-emergence method, the post-emergence method or the pre- and post-emergence method, to the plants, for example harmful plants, parts of plants, plant seed or the area on which the plants grow, for example the area under cultivation.

The crop plants may also be genetically modified or obtained by mutation/selection.

The invention also provides the use of the novel combinations of compounds (A)+(B) for controlling harmful plants, preferably in crop plants.

The herbicidal compositions according to the invention can also be employed non-selectively for controlling unwanted vegetation, for example in plantation crops, on roadsides, squares, industrial sites or railway tracks.

The active compound combinations according to the invention can be present both as mixed formulations of components (A) and (B), if appropriate with further agrochemically active compounds, additives and/or customary formulation auxiliaries, which are then applied in a customary manner diluted with water, or be prepared as so-called tank mixes by joint dilution of the separately formulated or partially separately formulated components with water.

The herbicides (A) and (B) can be converted into customary formulations, such as solutions, emulsions suspensions, powders, foams, pastes, granules, aerosols, natural and synthetic materials impregnated with active compound and microencapsulations in polymeric materials. The formulations may comprise the customary auxiliaries and additives.

These formulations are produced in a known manner, for example by mixing the active compounds with extenders, that is liquid solvents, pressurized liquefied gases and/or solid carriers, if appropriate with the use of surfactants, that is emulsifiers and/or dispersants, and/or foam formers.

If the extender used is water, it is also possible to use, for example, organic solvents as auxiliary solvents. Suitable liquid solvents are essentially: aromatics, such as xylene, toluene, alkylnaphthalenes, chlorinated aromatics or chlorinated aliphatic hydrocarbons, such as chlorobenzenes, chloroethylenes, or methylene chloride, aliphatic hydrocarbons, such as cyclohexane or paraffins, for example mineral oil fractions, mineral and vegetable oils, alcohols, such as butanol or glycol, and ethers and esters thereof, ketones, such as acetone, methyl ethyl ketone, methyl isobutyl ketone or cyclohexanone, strongly polar solvents, such as dimethylformamide or dimethyl sulfoxide, and also water.

Suitable solid carriers are: for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and also protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins and synthetic phospholipids, can be used in the formulations. Other possible additives are mineral and vegetable oils.

It is possible to use colorants such as inorganic pigments, for example iron oxide, titanium oxide and Prussian Blue, and organic dyes, such as alizarin dyes, azo dyes and metal phthalocyanine dyes, and trace nutrients, such as salts of iron, manganese, boron, copper, cobalt, molybdenum and zinc.

The formulations generally comprise between 0.1 and 95% by weight of active compound, preferably between 0.5 and 90% by weight.

The herbicides (A) and (B) can be used as such or in their formulations, including as a mixture with other agrochemically active compounds, such as known herbicides, for controlling unwanted vegetation, for example for controlling weeds or for controlling unwanted crop plants, ready mixes and tank mixes being possible.

Also possible are mixtures with other known active compounds, such as fungicides, insecticides, acaricides, nematicides, safeners, bird repellents, plant nutrients and soil conditioners.

The herbicides (A) and (B) can be applied as such, in the form of their formulations or the use forms prepared therefrom by further dilution, such as ready-to-use solutions, suspensions, emulsions, powders, pastes and granules. Application is effected in a customary manner, for example by watering, spraying, atomizing, broadcasting.

The active compounds can be applied to the plants (for example harmful plants, such as monocotyledonous or dicotyledonous weeds or unwanted crop plants), the seed (for example grains, seeds or vegetative propagation organs, such as tubers or shoot parts with buds) or the area under cultivation (for example the soil), preferably to the green plants and parts of plants and, if appropriate, additionally the soil. One possible use is the joint application of the active compounds in the form of tank mixers, where the optimally formulated concentrated formulations of the individual active compounds are, together, mixed in a tank with water, and the spray liquor obtained is applied.

A joint herbicidal formulation of the combination according to the invention of herbicides (A) and (B) has the advantage that it is easier to apply, since the amounts of the components are already in the right ratio. Moreover, the auxiliaries in the formulation can be adjusted optimally to one another, whereas a tank mix of different formulations may result in unwanted combinations of auxiliaries.

The good herbicidal action of the novel active compound combination is demonstrated by the examples below. Whereas the individual active compounds have weaknesses in the herbicidal action, the combinations all show very good activity against weeds which exceeds a simple addition of activity.

A synergistic effect in herbicides is always present when the herbicidal activity of the active compound combination exceeds the activity of the active compounds applied individually.

The expected activity for a given combination of two herbicides can be calculated as follows (cf. COLBY, S.R.: “Calculating synergistic and antagonistic responses of herbicide combinations”, Weeds 15, pages 20-22, 1967):
if
X=% damage by herbicide A (active compound of the formula I) at an application rate of p kg/ha
and
Y=% damage by herbicide B (active compound of the formula II) at an application rate of q kg/ha
and
   E=the expected damage of herbicides A+B at an application rate of p+q kg/ha
then
   E=X+Y−(X*Y/100).

If the actual damage exceeds the calculated value, the combination has a superadditive effect, that is to say a synergistic effect

The active compound combinations of the present invention do indeed have the property that their actual herbicidal activity is higher than the calculated activity, i.e. the novel active compound combinations act synergistically.

The reported results originate from field trials carried out in 2 to 3 repetitions. The weed grasses or crops are sown. The activities are assessed on three days; what is reported are the highest efficacies.

| | | % Activity | | |
|---|---|---|---|---|
| | g of a.i./ha | ALOMY | AGGRE | BROSTE |
| Ex. A.1 | 20 | 42 | 60 | 35 |
| Metazachlor (B 3.20) | 1000 | 28 | 10 | 45 |
| Ex. A.1 + Metazachlor | 20 + 1000 | 78 | 85 | 82 (35 + 45) |
| (B 3.20) | | (42 + 28) | (60 + 10) | |

| | | % Activity | |
|---|---|---|---|
| | g of a.i/ha | PESGL | TRZAS |
| Ex. A.5 | 20 | 70 | 69 |
| Glufosinate (B4.2) | 400 | 20 | 20 |
| Ex. A.5 + Glufosinate | 20 + 400 | 95 (70 + 20) | 93 (69 + 20) |
| (B4.2) | | | |

1. A herbicide composition comprising an effective amount of components (A) and (B), where
(A) is one or more herbicides selected from the group consisting of the compounds 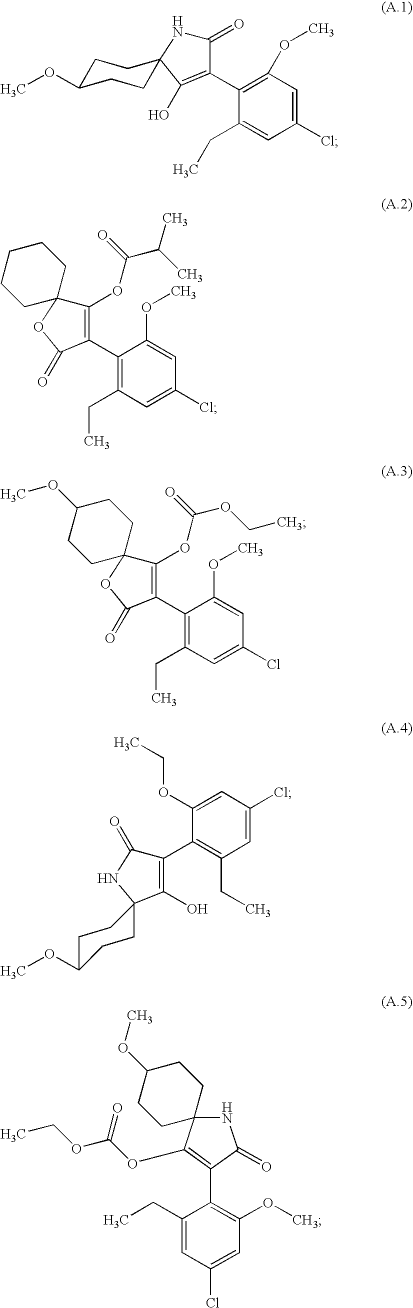 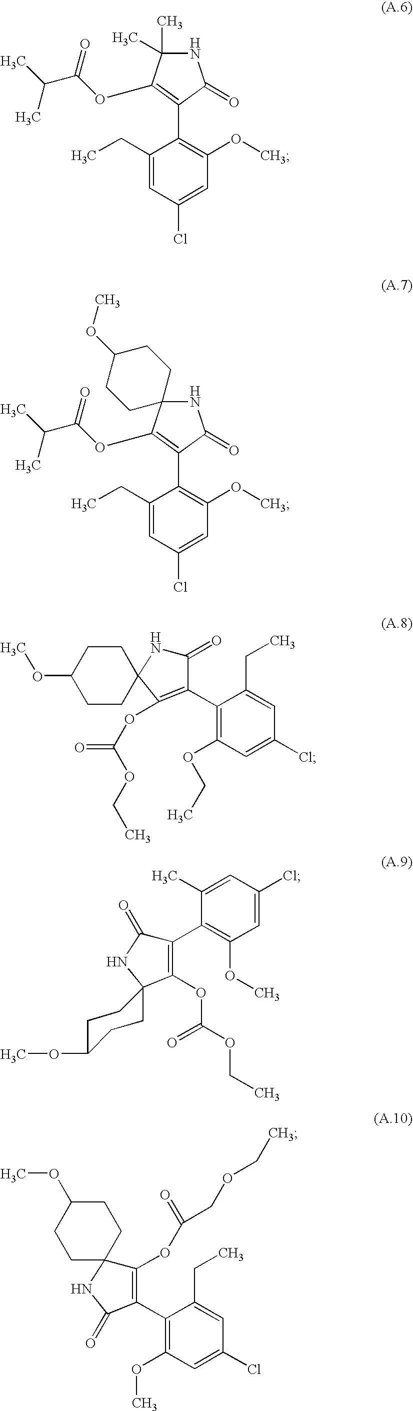 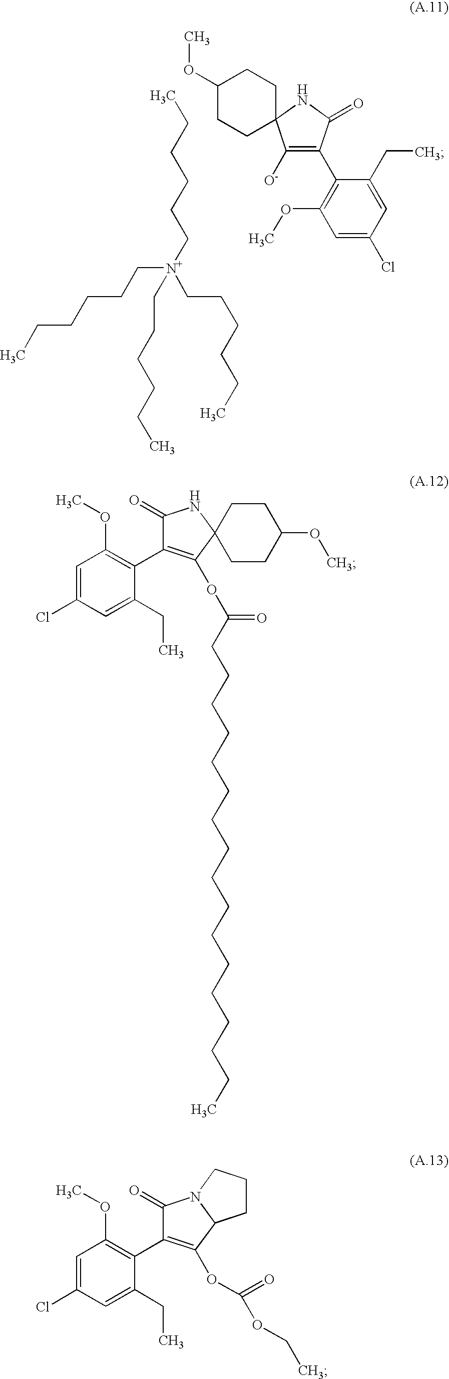 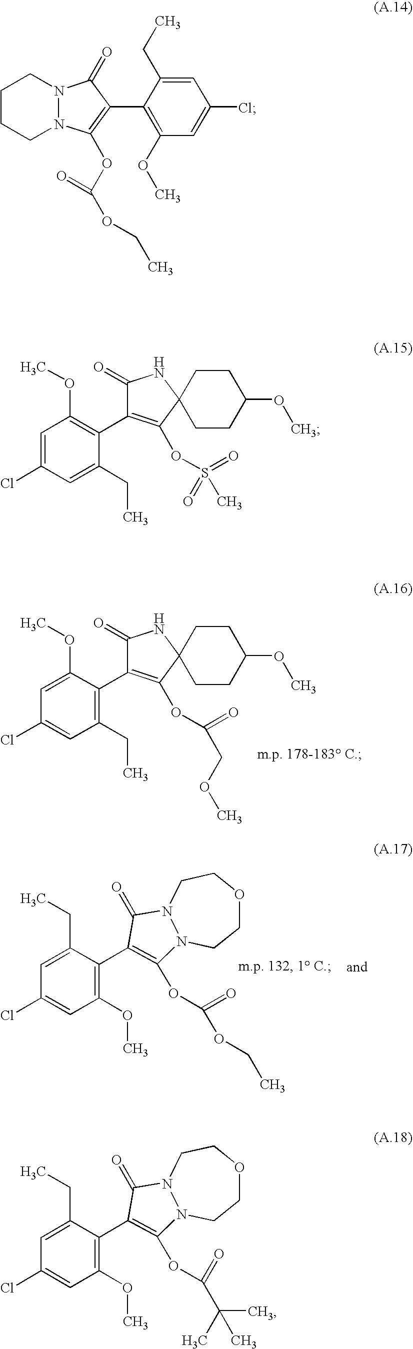
and
(B) is one or more herbicides selected from groups (B1) to (B4), wherein group (B-1) consists of
(B1.1) pinoxaden;
(B1.2) diclofop-methyl;
(B1.3) clodinafop-propargyl;
(B1.4) cyhalofop-butyl;
(B1.5) fenoxaprop-P-ethyl;
(B1.6) haloxyfop-P and its esters;
(B1.7) fluazifop-P-butyl;
(B1.8) quizalofop-P and its esters;
(B1.9) sethoxydim;
(B1.10) clethodim;
(B1.11) tepraloxydim;
(B1.12) mesosulfuron-methyl;
(B1.13) iodosulfuron-methyl and its salts;
(B1.14) sulfosulfuron;
(B1.15) flupyrsulfuron-methyl and its salts;
(B1.16) fentrazamide;
(B1.17) mefenacet;
(B1.18) imazamethabenz-methyl;
(B1.19) imazethapyr;
(B1.20) imazamox;
(B1.21) flurtamone;
(B1.22) isoproturon; and
(B1.23) quinclorac,
and
group (B-2) consists of
(B2.1) 2,4-DB;
(B2.2) dicamba;
(B2.3) clomazone;
(B2.4) triclopyr and its salts and esters;
(B2.5) fluoroxypyr and its salts and esters;
(B2.6) thifensulfuron-methyl;
(B2.7) amidosulfuron;
(B2.8) tribenuron-methyl;
(B2.9) metsulfuron-methyl;
(B2.10) picloram and its salts and esters;
(B2.11) carfentrazone-ethyl;
(B2.12) chlopyralid;
(B2.13) batafenacil;
(B2.14) isoxaben;
(B2.15) thiazopyr;
(B2.16) flurtamone;
(B2.17) aclonifen;
(B2.18) lactofen;
(B2.19) fomesafen;
(B2.20) chlorimuron-ethyl;
(B2.21) mesotrione;
(B2.22) sulcotrione; 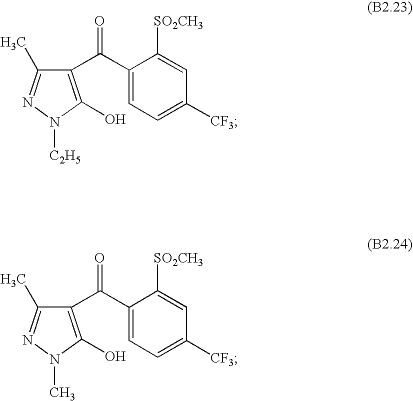
(B2.25) bromoxynil;
(B2.26) ioxynil;
(B2.27) diflufenican; and
(B2.28) picolinafen,
and
group (B-3) consists of
(B3.1) foramsulfuron;
(B3.2) iodosulfuron-methyl and its salts;
(B3.3) sulfosulfuron;
(B3.4) amicarbazone;
(B3.5) propoxycarbazone-sodium;
(B3.6) flucarbazone-sodium;
(B3.7) flufenacet;
(B3.8) metribuzin;
(B3.9) triasulfuron;
(B3.10) naproanilide;
(B3.11) imazapyr;
(B3.12) sulfosate;
(B3.13) simazine;
(B3.14) trifluralin;
(B3.15) pendimethalin;
(B3.16) oxadiargyl;
(B.3.17) oryzalin;
(B3.18) flazasulfaron;
(B3.19) sulfometuron-methyl;
(B3.20) metazachlor;
(B3.21) metolachlor;
(B3.22) S-metolachlor;
(B3.23) alachlor;
(B3.24) atrazine;
(B3.25) isoxaflutole;
(B3.26) quinmerac;
(B3.27) flumiclorac-pentyl;
(B3.28) quinclorac; 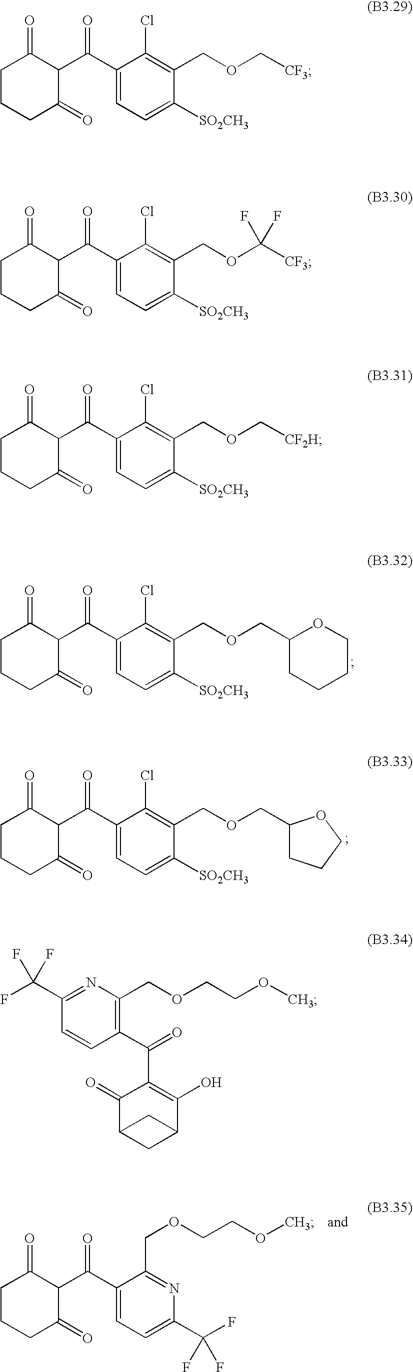 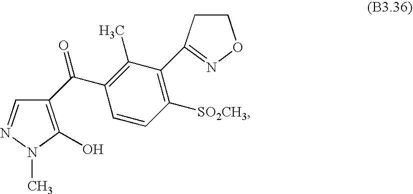
and
group (B-4) consists of
(B4.1) glyphosate;
(B4.2) glufosinate, also including glufosinate-P;
(B4.3) oxyflourfen;
(B4.4) diuron;
(B4.5) MSMA;
(B4.6) bromacil;
(B4.7) norflurazon;
(B4.8) azafenidin; and
(B4.9) tebuthiuron.

2. The composition of claim 1, additionally comprising one or more further components selected from the group consisting of agrochemically active compounds other than components (A) and (B), additives customary in crop protection and formulation auxiliaries.

3. The composition of claim 1, additionally comprising one or more safeners.

4. The composition of claim 1, wherein group (B1) consists of B1.2, B1.5, B1.12, B1.13, B1.16, B1.17, B1.21, B1.22, wherein group (B2) consists of B2.7, B2.16, B2.17, B2.18, B2.25, B2.26, B2.27, wherein group (B3) consists of B3.1, B3.2, B3.4, B3.5, B3.6, B3.20, B3.25, B3.29, B3.30, B3.31, B3.32, B3.33 and wherein group (B4) consists of B4.2, B4.4.

5. The composition of claim 3, where the safener is mefenpyr-diethyl.

6. The composition of claim 3, where the safener is 1,3-dimethylbut-1-yl (5-chloro-8-quinolinoxy)acetate.

7. The composition of claim 3, where the safener is isoxadifen-ethyl.

8. The composition of claim 3, where the safener is ethyl 1-(2,4-dichlorophenyl)-5-trichloromethyl-(1H)-1,2,4-triazole-3-carboxylate.

9. The composition of claim 3, where the safener is a compound of formula VIII 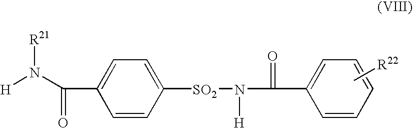
wherein R²¹ is cyclopropyl and R²² is 2-methoxy.

10. A method for controlling unwanted vegetation comprising contacting the vegetation, vegetation parts, vegetation seeds or the area in which the vegetation grows with components (A) and (B) of claim 1.

11. A method of controlling harmful plants comprising contacting the plants, plant parts, plant seeds or the area in which the plants grow with components (A) and (B) of claim 1.

12. The compound of the formula

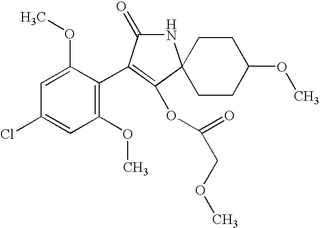

13. The compound of the formula

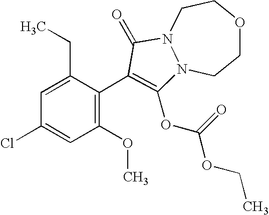

14. The compound of the formula

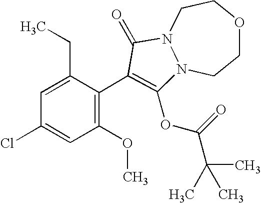

15. The composition of claim 2, wherein group (B1) consists of B1.2, B1.5, B1.12, B1.13, B1.16, B1.17, B1.21, B1.22, wherein group (B2) consists of B2.7, B2.16, B2.17, B2.18, B2.25, B2.26, B2.27, wherein group (B3) consists of B3.1, B3.2, B3.4, B3.5, B3.6, B3.20, B3.25, B3.29, B3.30, B3.31, B3.32, B3.33 and wherein group (B4) consists of B4.2, B4.4.

16. The composition of claim 3, wherein group (B1) consists of B1.2, B1.5, B1.12, B1.13, B1.16, B1.17, B1.21, B1.22, wherein group (B2) consists of B2.7, B2.16, B1.17, B2.18, B2.25, B2.26, B2.27, wherein group (B3) consists of B3.1, B3.2, B3.4, B3.5, B3.6, B3.20, B3.25, B3.29, B3.30, B3.31, B3.32, B3.33 and wherein group (B4) consists of B4.2, B4.4.

17. The method of claim 10, wherein said contacting of components (A) and (B) occurs jointly or separately.

18. The method of claim 11, wherein said contacting of components occurs jointly or separately.
